(19) United States
(12) Patent Application Publication
(10) Pub. No.: US 2026/0162662 A1
(43) Pub. Date: Jun. 11, 2026

(54) SYSTEM AND METHOD FOR SPEECH DETECTION

(71) Applicant: Alterego AI, Inc., Cambridge, MA (US)

(72) Inventors: Anthony Zorzos, Cambridge, MA (US); Arnav Kapur, Cambridge, MA (US); Bruno DoValle, Cambridge, MA (US); Max Newlon, Cambridge, MA (US); Scott Ren, Cambridge, MA (US); Shreyas Kapur, Cambridge, MA (US)

(73) Assignee: Alterego AI, Inc., Cambridge, MA (US)

(21) Appl. No.: 19/416,851

(22) Filed: Dec. 11, 2025

Related U.S. Application Data
(60) Provisional application No. 63/730,637, filed on Dec. 11, 2024.
(60) Provisional application No. 63/873,045, filed on Aug. 29, 2025.

(51) Int. Cl. G10L 15/22; G06V 40/20; G10L 25/27

(52) U.S. Cl. CPC G10L 15/22; G06V 40/20; G10L 25/27

(57) ABSTRACT

In variants, the silent speech detection system can include: a housing including a preauricular component that extends downward in front of the tragus of a user; and a sensor in the auricular region.

### CROSS-REFERENCE TO RELATED APPLICATIONS

This application claims the benefit of U.S. Provisional Application No. 63/730,637 filed 11 Dec. 2024 and U.S. Provisional Application No. 63/873,045 filed 29 Aug. 2025, each of which is incorporated in its entirety by this reference.

### TECHNICAL FIELD

This invention relates generally to the speech detection field, and more specifically to a new and useful system and method for detecting speech features in the speech detection field.

### BRIEF DESCRIPTION THE DRAWINGS

FIG. 1 is a schematic representation of a variant of the system.

FIG. 2 is a schematic representation of an example of the system.

FIG. 3 is an illustrative example of a headset variant of the system.

FIG. 4 is an illustrative example of a headset variant of the system with additional sensors.

FIG. 5 is an illustrative example of a headset variant of the system in situ.

FIG. 6 is an illustrative example of a sensor placement relative to a user's skull.

FIG. 7 is an illustrative example of a different head positions that the system is operable in.

FIG. 8 is an illustrative example of a glasses variant of the system.

FIG. 9 is an illustrative example of an extended reality headset variant of the system.

FIG. 10 is an illustrative example of an over-ear headset variant of the system.

FIG. 11 is a schematic representation of a variant of the method.

FIG. 12 is a schematic representation of converting the linguistic unit to different output modalities.

### DETAILED DESCRIPTION OF THE INVENTION

The following description of the embodiments of the invention is not intended to limit the invention to these embodiments, but rather to enable any person skilled in the art to make and use this invention.

### 1. Overview

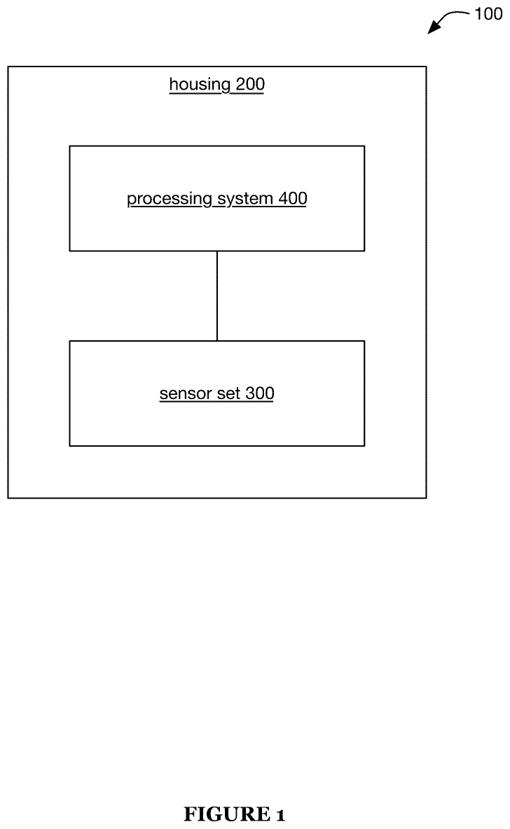

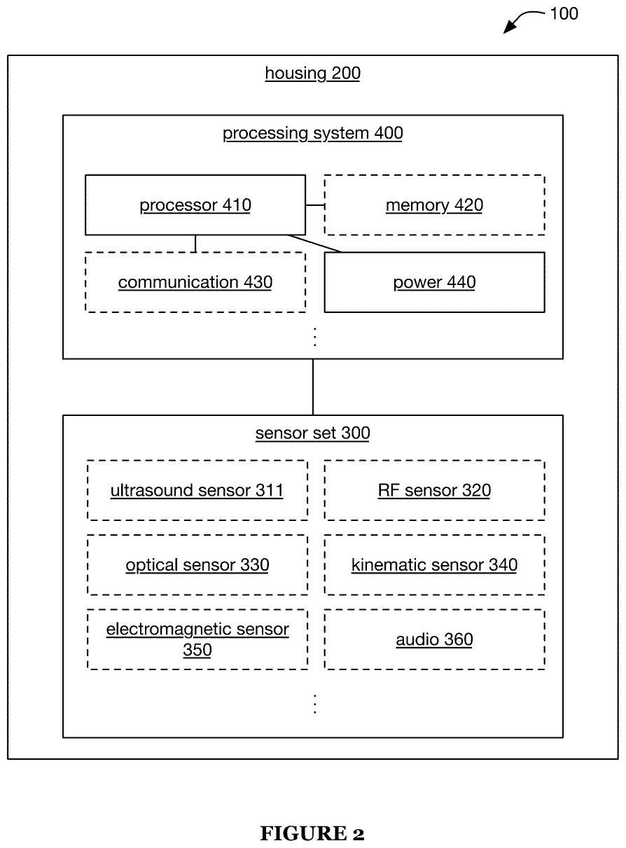

As shown in FIG. 1, variants of the system 100 can include: a housing 200; a set of sensors 300; and a processing system 400. The system functions to noninvasively measure speech articulators involved in speech production. In examples, the systems are shown in FIG. 1 and FIG. 2.

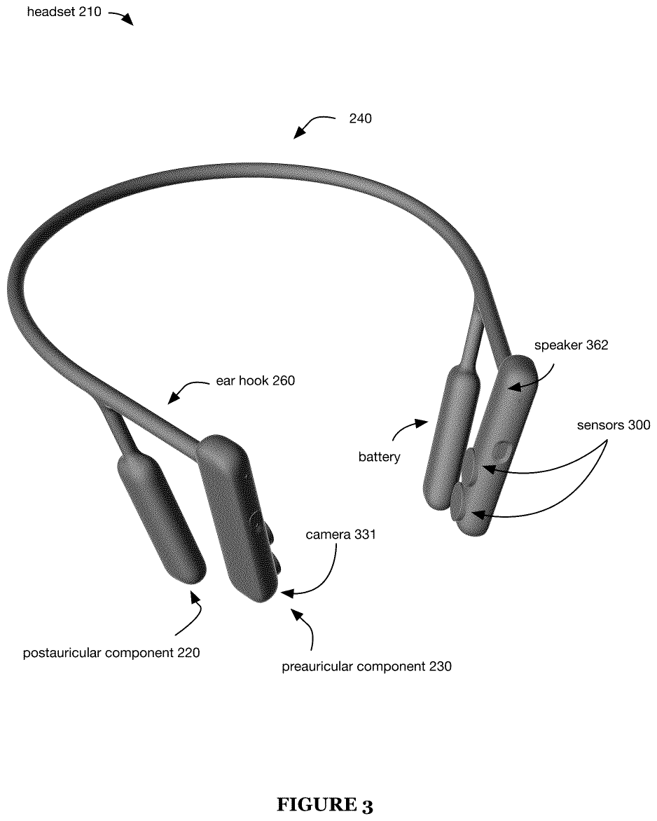

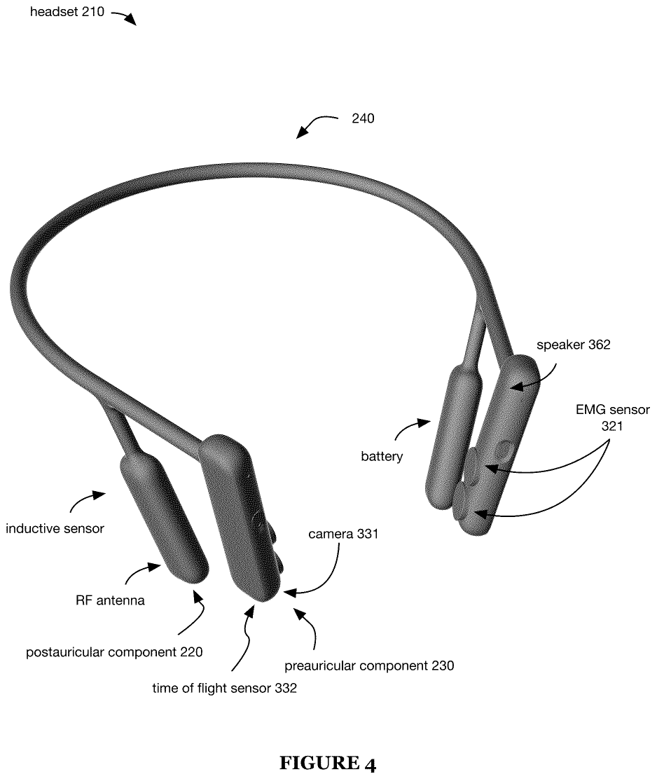

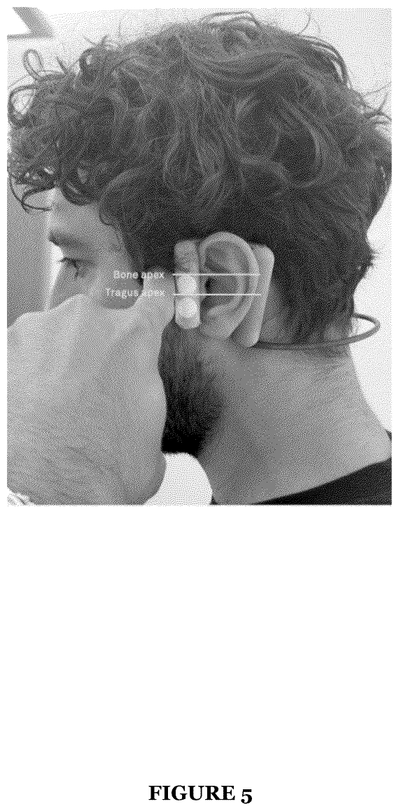

In an illustrative example, the system can include: a housing including a preauricular downstem that extends downward in front of the tragus of a user and a postauricular downstem that extends downward behind the ear and adjacent the mastoid process of the user; a set of biophysical sensors arranged in the housing; and an optional set of cameras mounted to the preauricular downstem, the bottom of a set of spectacle frames, and/or to a nose bridge to measure the ambient environment and/or external facial contortions. Examples are shown in FIG. 3, FIG. 4, and FIG. 5. The system can measure parameters of speech articulators (e.g., pose, motion, etc.); and determine linguistic units based on the parameters (e.g., with a neural network, etc.). However, the system can be otherwise constructed.

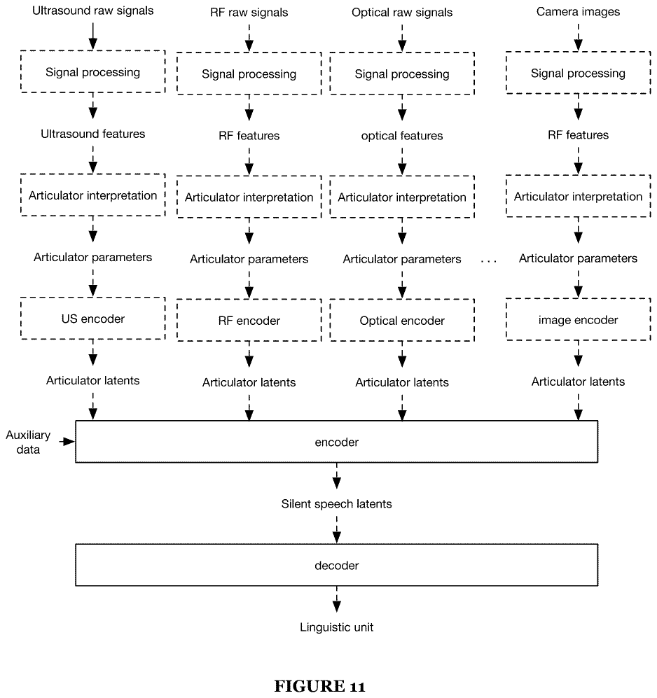

An illustrative example, the method of operating the system can include:
measuring a set of subvocal speech measurements using a set of sensors; optionally extracting a set of features (e.g., articulator parameters, embeddings, etc.) from the set of subvocal speech measurements; and determining (e.g., inferring, predicting) a set of speech representations from the set of features (e.g., linguistic units, etc.). An example is shown in FIG. 11.

However, the system/method can be otherwise performed.

### 2. Technical Advantages

Variants of the technology can confer one or more advantages over conventional technologies.

First, variants of the technology can enable noninvasive measurement of speech articulator movement. By utilizing external sensors (e.g., ultrasound measurements of in-cavity articulators, surface electromyography of articulator-controlling muscles, optical tracking, etc.) positioned on or near the face and neck, the system can capture articulator movements without requiring surgical implantation or internal probes. For example, the technology can detect subtle muscle activations and tissue deformations associated with tongue, lip, and jaw movements during speech production. This noninvasive approach can significantly reduce patient discomfort, eliminate surgical risks, and broaden the potential user base for speech monitoring and assistive communication technologies, while still providing valuable data about articulation processes that were previously only obtainable through more invasive methods.

Second, variants of the technology can achieve reliable silent speech detection from non-optimal sensor locations constrained by wearable form factors. Whereas conventional silent speech interfaces may require precise sensor placement directly over specific articulators or muscles, the present technology can compensate for suboptimal sensor arrangements necessitated by practical wearable designs.

For example, the system enables sensors integrated into everyday items such as eyeglasses frames, earpieces, or necklaces can still capture useful speech-related signals despite their non-ideal positioning. The system can employ advanced signal processing techniques, including adaptive filtering, source separation algorithms, and machine learning models trained on diverse data, to extract meaningful articulation information from noisy and uncertain measurements. This capability can enable more practical and socially acceptable silent speech interfaces that can be used in everyday contexts without compromising detection reliability.

Third, certain variants of the technology can provide higher spatial-resolution sensing by selecting sensor placements with optimal acoustic propagation paths. Ultrasound sensors generally couple more efficiently into soft tissue than RF sensors, enabling finer detection of small articulator deflections. However, ultrasound does not penetrate bone as effectively as RF. Accordingly, positioning the sensor such that its acoustic path passes primarily through soft tissue allows ultrasound to be used in place of RF for reliable, high-resolution measurement of motions of articulators such as the tongue, lips, floor of mouth, and larynx.

However, further advantages can be provided by the system and method disclosed herein.

### 3. System

As shown in FIG. 1, variants of the system include: a housing 200; a set of sensors 300; and a processing system 400. The system functions to noninvasively measure speech articulators involved in speech production. In examples, the systems are shown in FIG. 1 and FIG. 2.

The speech articulator measurements can be used to detect and/or interpret subvocal speech, nonverbal speech, vocalized speech, and/or any other speech. Subvocal speech can include silent speech (e.g., mouthed speech, unmouthed speech, articulated but inaudible speech, etc.), whispered speech, and/or other subvocal speech. Subvocal speech can be produced using little or no airflow through the vocal folds, voicing, and/or other acoustic output.

In variants, the system can optionally use sampled sensor measurements to determine commands (e.g., verbal commands, nonverbal commands, etc.), and/or other verbal or nonverbal communication.

The speech articulators that are monitored can include one or more of: tongue, lips, jaw, cheeks, facial muscles (e.g., that control the tongue, lips, jaw, etc.), vocal folds, glottis, velum, hard palate, alveolar ridge, scalp, ear canal, and/or any other speech articulators.

The system can sample measurements indicative of one or more parameters of each monitored speech articulator. Examples of parameters that can be monitored can include: received signal parameters (e.g., amplitude, phase, frequency, direction, etc.), configuration (e.g., pursed lips, etc.), pose (e.g., position, orientation, etc.), contour (e.g., maxima, splines, etc.), displacement (e.g., bulk displacement), deformation, vibration (e.g., bone vibration, cheek vibration, etc.), citation (e.g., electromyography, electrical activity, etc.), ripple, learned parameters (e.g., non-human-readable features), position relative to a reference structure (e.g., wherein the reference structure can be a system reference, a physiological reference, a hard tissue reference, such as the hard palate, etc.), derivative parameters of other parameters, and/or any other parameters. Example derivative parameters of other parameters can include timeseries of parameter values, changes between successive measurements, changes over time (e.g., change in position, velocity, acceleration, etc.), statistical measures (e.g., mean, median, distribution, etc.), aggregations (e.g., weighted aggregate, fused sensor measurements, etc.), and/or any other derivative parameters.

The system can directly measure the speech articulator, indirectly measure the speech articulator, regions coupled with articulator motion, and/or otherwise measure the speech articulator. In an example, tongue position can be determined by monitoring the tongue-control muscles. In another example, lip motion can be measured by monitoring cheek ripples. In another example, larynx motion associated with tongue movement can be measured.

The system can be used during spoken speech, mouthed speech (e.g., non-vocal, inaudible, wherein the speech is silently mouthed or formed), unmouthed speech (e.g., without discernable speech, closed mouth speech, wherein the system can detect and infer speech from the muscle signals sent from the brain to the speech articulators), and/or any other speech type.

In variants, the system can be used for: silent speech note taking, querying a knowledge base (e.g., the internet, personal notes, etc.), querying or interacting with media (e.g., interacting with audio playback, virtual reality streamed to a headset, etc.), interacting with an external device (e.g., dictating on a phone, editing content on another device, etc.), sending text communications with other entities (e.g., text, email, applications, interacting with AI agents to complete tasks, virtual personal assistants, etc.), sending spoken communications with other entities (e.g., other users, other devices, etc.), querying about the ambient environment (e.g., about the environment or items therein captured by the camera, audio sensors, etc.), interacting with information depicted in measurements of the ambient environment (e.g., about the environment or items therein captured by the camera, audio sensors, etc.), as a medical accessory (e.g., for people with speech impediments, etc.), and/or otherwise used.

In a first example, sending spoken communications with other entities can include detecting silent speech, converting the silent speech to text, and converting the text to synthetic voice that is sent to another entity (e.g., another user). In a second example, sending spoken communications with other entities can include detecting silent speech and converting the silent speech to synthetic voice. In a third example, sending spoken communications with other entities can provide real-time multi-lingual conversation.

In a first example, interacting with information depicted in measurements of the ambient environment can include triggering a set of actions based on detected user gestures (e.g., circling, pointing, underlining with fingers, etc.) relative to objects or other reference points in the ambient environment, triggering a set of actions based on a user gesture in conjunction with silent speech, and/or controlling applications and/or accessories with silent speech inputs. In a first specific example, triggering a set of actions based on detected user gestures can include recording notes based on a first gesture from the user. In a second specific example, triggering a set of actions based on detected user gestures can include triggering a predetermined action based on a second gesture from the user. In a third specific example, triggering a set of actions based on detected user gestures can include interpreting text selected by a user on a laptop and using the text as context for a silent speech input. In a fourth specific example, triggering a set of actions based on detected user gestures can include detecting a second user wearing a silent speech system, communicatively connecting to the second user's silent speech system, interpreting linguistic units based on the user's subvocal speech signals, and transmitting and/or receiving speech from the second user's silent speech system.

In a second example, interacting with information depicted in measurements of the ambient environment can include triggering a set of actions based on a user gesture in conjunction with silent speech. In a specific example, this can include a user gesturing to an element of the environment in conjunction with a silent speech query.

In a third example, interacting with information depicted in measurements of the ambient environment can include controlling applications and/or accessories with silent speech inputs. In a first specific example, controlling applications and/or accessories can include connecting to an application (e.g., within a desktop or an IoT device) to access the application/accessory. In a second specific example, controlling applications and/or accessories can include controlling applications and/or accessories based on what the user is looking at (e.g., based on objects and/or features detected within the field of view of the front facing camera). In a third specific example, controlling applications and/or accessories can include interacting with options based on a user gesture extracted from a set of kinematic measurements (e.g., head moving left and/or right), head moving up and/or down, nodding, shaking head). The third specific example can include providing audio to the user in response to the user gesture.

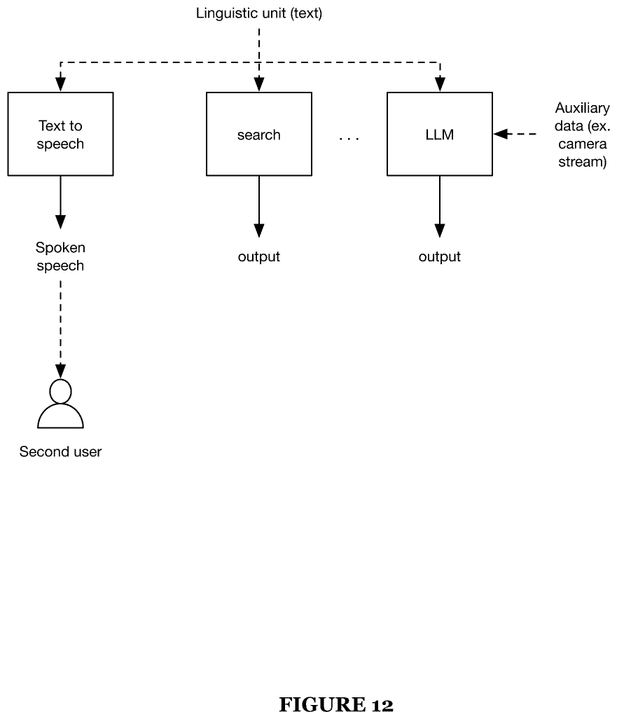

An example of the system is shown in FIG. 12.

In variants, the system can be operable between a set of operation modes. Examples of operation modes that can be used include: a spoken mode (e.g., user audio mode, etc.; e.g., wherein speech articulators are not actively monitored, are intermittently monitored, or are given less weight when interpreting speech); a silent mode (e.g., subvocal speech mode, etc.; e.g., wherein speech articulators are monitored by the system sensors and given more weight when interpreting speech); a listening mode (e.g., where the system is listening for a trigger); a sleep mode (e.g., wherein the majority of the sensors are off, wherein the system is in a low power consumption state, wherein the system can be activated by a wake trigger); and/or any other operation modes.

In variants, the system can switch between operation modes in response to detection of one or more user triggers (e.g., commands, gestures), when a predetermined set of environmental conditions is detected, and/or at any other time.

Examples of triggers that can be used include detection of: a tap, a button press, a predetermined head motion, a predetermined eye movement, a predetermined eye blink pattern, a predetermined sound, the ambient sound surpassing (e.g., falling above or below) a predetermined threshold, a predetermined articulator motion (e.g., a predetermined tongue movement, predetermined soft palate movement, etc.), facial clenching, a predetermined facial expression, a predetermined hand gesture, a predetermined body gesture, a predetermined linguistic unit, and/or any other triggers. Triggers can be received at the system, an accessory, a user device, and/or any other device. In a specific example, receiving a button press at a ring accessory can trigger an operation mode.

Examples of sets of environmental conditions that can be used include an ambient volume threshold (e.g., switching to silent mode when an ambient volume exceeds a first volume threshold, when the ambient volume falls below a second volume threshold, etc.), a location, an ambient light threshold, an indoor or outdoor state, number of people present (e.g., adjacent occupancy, proximity to other users, etc.), a time of day, a vehicle state, a user kinematic state (e.g., switch to spoken mode when the user is in a high-kinematic state, switch to silent mode when the user is at rest or in a low-kinematic state, etc.), and/or any other sets of environmental conditions.

In a specific example, the system can switch from spoken mode to silent mode when the ambient volume (e.g., sampled at the microphone) exceeds a predetermined threshold.

Different operation modes can be associated with different combinations of passive and/or active sensors (e.g., powered sensors, sensors in a sampling state, etc.), or use the same combination of sensors (e.g., with different sampling frequencies, different prioritization, etc.).

In a first example, in a sleep mode, the ultrasound, RF, optical, kinematic, and/or EMG sensors can be inactive, and a mechanical state sensor can be active to detect a wake trigger (e.g., reaching a strain threshold on a section of the housing, detecting deformation, etc.). In this example, the mechanical state sensor can run at a lower sampling rate than in the silent mode.

In a second example, in a sleep mode, the ultrasound, RF, optical, and/or EMG sensors can be inactive, and a kinematic sensor can be active to detect a wake trigger (e.g., detecting motion above a threshold, detecting acceleration above a threshold, etc.). In this example, the kinematic sensor can run at a lower sampling rate than in the silent mode.

In a third example, in a spoken mode, the audio sensors can be active. In a third example, in a silent mode, the sensors related to silent speech (e.g., ultrasound sensors, RF sensors, optical sensors, kinematic sensors, EMG sensors, etc.) can be active.

In a fourth example, in a listening mode, the audio sensors can be selectively active (e.g., when a trigger gesture, signal, or sound is detected).

In a fifth example, the articulator measurements (e.g., sampled by the articulator sensors, such as ultrasound, RF, time of flight, etc.) can be used as the primary input signals for speech determination with auxiliary measurements functioning as validation or conditioning signals in a first mode (e.g., in the silent mode), while auxiliary measurements (e.g., acoustic measurements) can be used as the primary speech determination signals with articulator measurements functioning as the validation or conditioning signals in a second mode (e.g., spoken mode).

In a first specific example, the system can run in a low-power mode by default, and switch into a high-power mode (e.g., power the articulator measurement sensors) when the trigger is detected by a low-power sensor operating during the low-power mode.

In a second specific example, the system can switch from the spoken mode to the silent mode when background or ambient noise received from the microphone exceeds a predetermined threshold (e.g., “infinite noise reduction”). In this example, the speech sent to the other entity can be switched from a recording of the user's voice (in the spoken mode) to the synthesized user's voice generated from text inferred from the measured speech articulator parameters (in the silent mode). For example, the system can accurately record notes, to query a model, and/or perform other functionalities regardless of the acoustic environment.

In a third specific example, the system can switch modes when environmental conditions detected from a set of camera frames (e.g., entering a crowded place, entering a building, etc.) satisfies a trigger.

However, the system can be otherwise configured.

### 3.1 Housing

The housing 200 of the system functions to retain the sensors relative to the user. The housing 200 preferably retains the sensors along an exterior of the user, but can alternatively retain one or more of the sensors inside the user, inside a cavity of the user, and/or in any other location. The housing 200 preferably biases the sensors against the user, but can alternatively retain the sensors on the surface of the user (e.g., user's skin), retain the sensors away from the user, and/or otherwise position the sensors relative to the user. The system can bias the sensors against the user using: the housing material (e.g., wherein the housing's spring modulus is tuned to achieve a predetermined bias force); spring-mounted sensors; an adhesive; a headband, a spring-loaded arm, and/or any other biasing mechanism. The biasing mechanism can be separate from the housing or be integral with the housing (e.g., the housing functions as the biasing mechanism). In an example, the housing can be tuned to generate sensor compression forces of 1-20 kPa, 2-15 kPa, 3-8 kPa, 4-10 kPa, or any range or value therebetween, but can alternatively be tuned to generate higher or lower compression forces.

The housing 200 preferably defines a wearable, but can alternatively be otherwise configured.

The housing can include a left segment opposing a right segment across the head of a user, but can alternatively include one segment on a lateral side, a central segment, a posterior segment, three or more segments arranged at distributed locations around the head, or any number of segments arranged at uniform or nonuniform locations around the head. In a variant with a left and right segment, the segments can include the same combination of elements, or a different combination of elements.

The housing 200 can include one or more user inputs (e.g., buttons, microphones, touch sensors, etc.), user outputs (e.g., speakers, displays, haptic feedback, etc.), and/or other components.

The housing 200 can be made of or include a material that: limits undesired coupling (e.g., acoustic, mechanical, capacitive, inductive, EMI, RFI, thermal, vibrational, electrostatic, optical, etc.) between an acoustic signal and the housing; improves acoustic impedance matching between soft tissue and a sensor (e.g., an ultrasound sensor); and/or otherwise improves the signal-to-noise ratio.

The housing can be arranged flush with the sensor, interface with the sensor, surround the sensor, and/or be otherwise arranged relative to the sensor. The sensor can be arranged within the housing, adhered to the surface of the housing, at an aperture, and/or any other arrangement.

The housing can include a polished surface, a single layer of impedance matching material, multiple layers of impedance matching materials (e.g., stepped impedances), and/or any other impedance matching mechanisms. In a first example, the housing can include adhesives, gels, and/or coupling pads placed between the housing and the user (e.g., skin) to improve signal-to-noise ratio. In a second example, the housing can include a film (e.g., a metamaterial, polyurethane film, silicone membrane, polymer coating, etc.) between the sensor and user (e.g., skin, tissue, etc.) to improve the signal-to-noise ratio.

The housing can optionally include a mechanical isolation element, which functions to improve interface compliance between the sensor and the user, bias the sensor against the user, reduce mechanical noise and vibrations, minimize housing-sensor coupling, improve acoustic isolation (e.g., to prevent acoustic coupling between an ultrasound sensor and the housing), limit mechanical crosstalk between system sensors, reduce motion artifacts, improve user comfort, protect sensor elements, and/or perform other functionalities. The mechanical isolation element is preferably located between the housing and the sensor (e.g., the sensor mounts to the housing via or through the mechanical isolation element), but can alternatively be otherwise arranged.

The mechanical isolation element can include: a damping interface between the housing and the sensor, a compliant sensor suspension, a spring mount, magnetic suspension, a mass-loading element (e.g., dense metal components, ceramic inserts, etc.), and/or any other mechanical isolation element.

The mechanical isolation element can optionally be coupled to a set of sensors (e.g., strain gauges, force sensors, etc.), which can function to sample the interaction force between the sensor and housing and/or sensor and user. The sampled interaction force can be used to adjust sampled signal interpretation, provide user instructions for headset adjustment, and/or otherwise be used.

The housing can optionally include acoustic barriers (e.g., microstructured materials, phononic crystals, metamaterials) to block specific acoustic frequencies. The acoustic barriers can be arranged adjacent the acoustic sensors, between the acoustic sensors and the housing, and/or be otherwise arranged. The acoustic barriers can include periodic structures (e.g., lattice spacing, apertures, alternating materials, cavity dimensions, thickness, etc.) which create acoustic stopbands. In an example, the acoustic stopbands can include attenuating wavelengths between 0.5-1.0 times the periodic feature size or any range or value therebetween (e.g., 0.6, 0.7, 0.8, 0.9 times the periodic feature size). The attenuating wavelengths can alternatively be less than 0.5 times or greater than 1.0 times the periodic feature size. In an example, the apertures can attenuate wavelengths smaller than the diameter of the aperture.

The acoustic barriers can include local resonators (e.g., membranes, masses, Helmholtz-like cavities) which resonate at specific frequencies, attenuating energy at that frequency. The local resonators can block frequencies with features much smaller than the associated wavelength of the frequency. The local resonators can include various masses, stiffnesses, cavity volumes, neck geometries (e.g., of a Helmholtz-like cavity), thicknesses, tensions, and/or any other parameters.

The acoustic barriers can include can include an acoustic impedance mismatch layer. The mismatched acoustic impedances can reflect and/or attenuate frequencies. The acoustic impedance mismatch layer can include various layer thicknesses, densities, moduli, boundary geometries, and/or any other properties.

However, the acoustic barriers can be otherwise configured.

Examples of housing materials that can be used can include Elastomeric Polyurethane (DLS), FDM TPE (FDM), FDM TPU (FDM), Flexible Resin (SLA), Elastic Resin (SLA), Silicone Rubber (Inkjet), FDM TPU (FDM), SLS/MJF Flexible TPU (SLS), nitinol wire, metamaterials, and/or any other housing materials. The metamaterials can enable sensing, steering, focusing, shielding, and/or manipulating signals. The metamaterials can include properties related to electromagnetic, acoustic, mechanical, thermal, and/or any other properties. The metamaterials can alter propagation of waves (e.g., concentrating fields, steering beams, localizing signals, etc.) and/or can scale mechanical motions, create mechanical filters, create waveguides for vibrations, etc. The metamaterials can include repeating unit cells (e.g., sub-wavelength structures) enabling a predetermined and/or variable impedance, permittivity, permeability, refractive index, and/or any other characteristics. The metamaterials can be arranged interior or exterior to the housing.

However, the housing can be otherwise constructed.

The housing can be: a set of headphones (e.g., in-ear earbuds, in-ear hooks, clip-on earbuds, over-ear earbuds, wired earbuds, wireless earbuds, neckband earbuds, over-ear headphones, earmuffs, canal caps, earplugs, hearing protection devices, etc.), a headset (e.g., a VR headset, a silent speech headset, etc.), glasses, a necklace, a clip (e.g., that clips to a shirt or hat), a face mask, goggles, a nose-mounted device (e.g., nose clip, nose ring, etc.), chin strap, headband, lip-mounted device (e.g., lip clip, lip ring, etc.), smart patch, and/or have any other form factor.

The housing 200 can include a set of tines (e.g., to comb through hair, generate redundant contact user contact points, etc.), a smooth surface, protrusions, divots, ridges, and/or have any other set of surface features.

In a first variant, the housing 200 can include a headset 210. The headset can include an ear retention mechanism, a preauricular component, an optional postauricular component, an optional ear interface, an optional band, and/or any other components.

The ear retention mechanism can retain the components (e.g., preauricular component 230, a postauricular component 240, etc.) on a user's ear, can connect a preauricular component 230 and a postauricular component 240 on a lateral side of the head of the user, and/or can retain the housing on the user's head by straddling the ear, rest over the top of the ear, and/or be otherwise configured.

The preauricular component (e.g., anterior segment) can be mounted in front of the ear hook, or otherwise arranged. The preauricular component is preferably straight (e.g., linear), but can alternatively be a circle, curved, an annulus, a triangle, and/or have any geometry. The preauricular component is preferably arranged vertically (e.g., extends downward in front of the ear), but can alternatively be arranged horizontally and/or in any configuration. In an example, the preauricular component can include a set of preauricular elements. The set of preauricular elements can include: a set of ultrasound sensors (e.g., a set of ultrasound transducers, an ultrasound array, a set of ultrasound probes, etc.), a set of optical sensors (e.g., cameras, etc.), a set of kinematic sensors (e.g., IMU, etc.), a processing system, a set of acoustic sensors, a radio frequency (RF) sensor, and/or any other preauricular elements. The preauricular component can be between 20-35 mm long or any range or value therebetween (e.g., 25-30 mm long). The preauricular component can alternatively be longer or shorter than 20 mm or greater than 35 mm.

The set of preauricular elements can be mounted to the interior of the preauricular component, be flush with the exterior of the preauricular component (e.g., extend through the preauricular component housing), be mounted proud of the preauricular component housing, and/or be otherwise mounted to the preauricular component.

In an example, the set of ultrasound sensors can be mounted flush with the exterior of the preauricular component (e.g., on the side of the preauricular component proximal the user), such that the set of ultrasound sensors contact the user when the headset is worn.

In an example, the preauricular component can position the sensors near the zygomatic arch (e.g., to detect tongue movement through a narrow line of sight to the tongue through a cavity defined by the arch; to detect cheek surface deformations; etc.), near the tragus (e.g., aligned with the tragus; within 1 mm, 2 mm, 3 mm, 4 mm, 5 mm, and/or any other distance above and/or below the tragus; etc.), and/or otherwise position the sensors to access viewing windows through the skull to the articulators.

In a specific example, the preauricular component can position the sensors above and/or below the zygomatic arch (e.g., span the zygomatic arch, bracket the zygomatic arch, straddle the zygomatic arch, etc.).

However, the preauricular component can be otherwise configured

The optional postauricular component (e.g., posterior segment) can be mounted to a rear end of the ear hook, or otherwise arranged. The postauricular component is preferably straight (e.g., linear), but can alternatively be a circle, curved, an annulus, a triangle, and/or have any geometry. The postauricular component is preferably arranged vertically (e.g., extends downward behind the ear), but can alternatively be arranged horizontally and/or in any configuration.

The postauricular component can include a set of postauricular elements. The set of postauricular elements can include: a set of RF sensors (e.g., a set of RF transducers, an RF array, a set of RF probes, etc.), a set of kinematic sensors (e.g., IMU, etc.), a processing system, a power supply (e.g., battery), a set of user inputs, an ultrasound sensor, and/or any other postauricular elements. The set of postauricular elements can be mounted to the interior of the postauricular component, be flush with the exterior of the postauricular component (e.g., extend through the postauricular component housing), be mounted proud of the postauricular component housing, and/or be otherwise mounted to the postauricular component.

The postauricular component can position sensors near the mastoid process (e.g., to monitor muscle groups that control tongue and lip movements; in the area where the tongue muscles connect near the mastoid process, etc.), the superior nuchal line, the temporal line, the styloid process of the temporal bone, the trapezius lateral edge, the conchal rim, the antihelix, the posterior auricular muscles, and/or near any other suitable user reference. In a specific example, the postauricular component can be arranged behind the earlobe and above the mastoid process.

The postauricular component can be substantially the same length as the preauricular component, but can alternatively be longer or shorter. The postauricular component (e.g., in addition to or exclusive of the retention mechanism or ear hook) can have the same mass as the preauricular component (e.g., with all preauricular system components mounted within the preauricular component and all the postauricular system components mounted within the postauricular component) to counterbalance the preauricular component. Alternatively, the postauricular component can have a higher or lower mass than the preauricular component (e.g., to improve comfort, preauricular component contact with the user, etc.).

However, the postauricular component can be otherwise configured.

The optional ear interface can include an in-ear interface (e.g., earbud), an over-ear interface (e.g., ear cup, etc.), and/or can orient a set of acoustic elements (e.g., speakers such as open-ear speakers, in-ear speakers, bone conduction speakers) toward the user (e.g., the ear canal, cheekbone, zygomatic arch, mastoid process). The ear interface can include: a sound port or nozzle, an ear tip mounted to the nozzle, a housing mounted to the nozzle (e.g., housing the drivers, voice coil, diaphragm, PCB, microphones, battery, antenna, sensors, etc.), and/or any other ear interface components.

The optional band 240 can retain the headset on the user's head by wrapping around the user's head. Alternatively, the system can exclude a band. The band can be arranged: behind the neck, behind the head, over the crown of the head, and/or any other arrangement. The band can bias the left and right segments against the user, bias a single segment against the user, and/or bias any other set of segments against the user. The band can generate a force between 3-10 kPa or any range or value therebetween on the user's head. The band can alternatively generate a force less than 3 kPa or greater than 10 kPa.

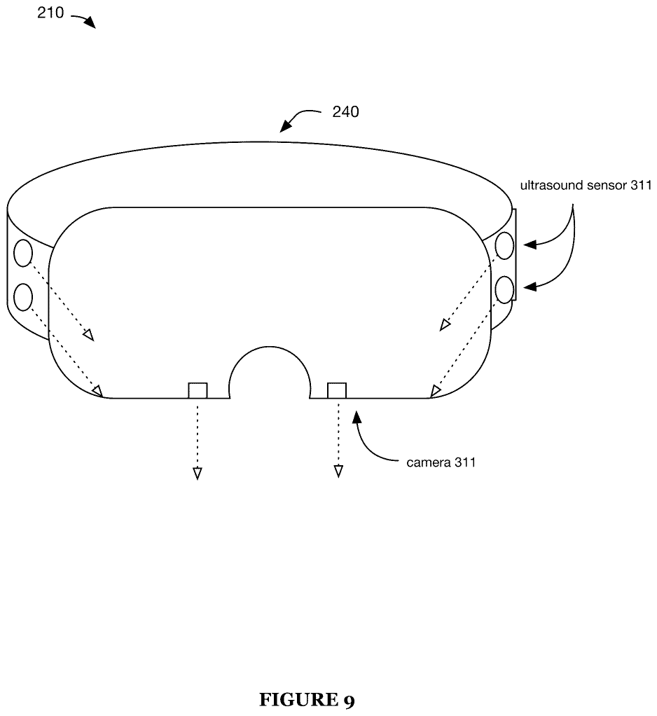

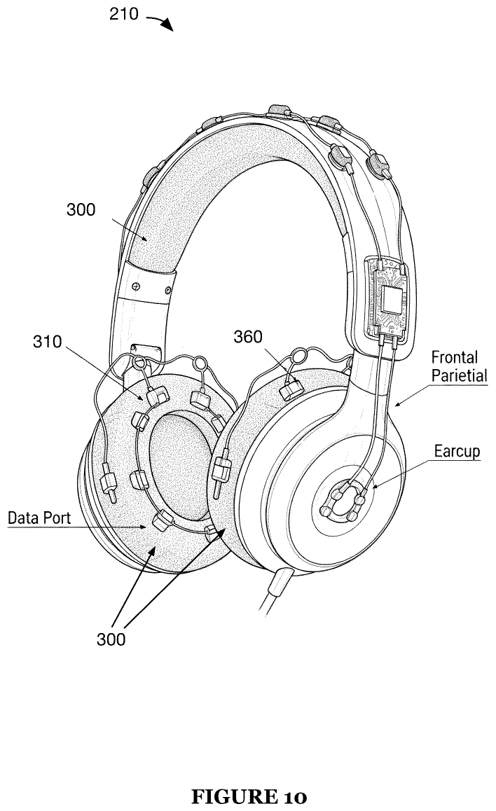

The band can connect two or more segments of a system (e.g., a left and a right segment), attach to opposing sides of the housing, attach to one or more points of the housing, and/or otherwise connect components. The band can include a neck band, an over-head band, a strap, a band wrapping behind the head, and/or any other band type. The band can be semi-rigid, rigid, flexible, elastic, inelastic, and/or any other band configuration. The band can include a nitinol wire, foam padding, fabric padding, plastic, and/or any other material. In a first variant, the band can be a flexible strap attached to two points of the housing and wrap around the head (e.g., as shown in FIG. 9). In a second variant, the band can be a semi-rigid band bridging between a left and right segment. In this variant, the band can wrap behind the head (e.g., as shown in FIG. 3 and FIG. 4), can wrap over the crown of the head (e.g., as shown in FIG. 10), and/or be otherwise configured.

However, the headset can be otherwise configured.

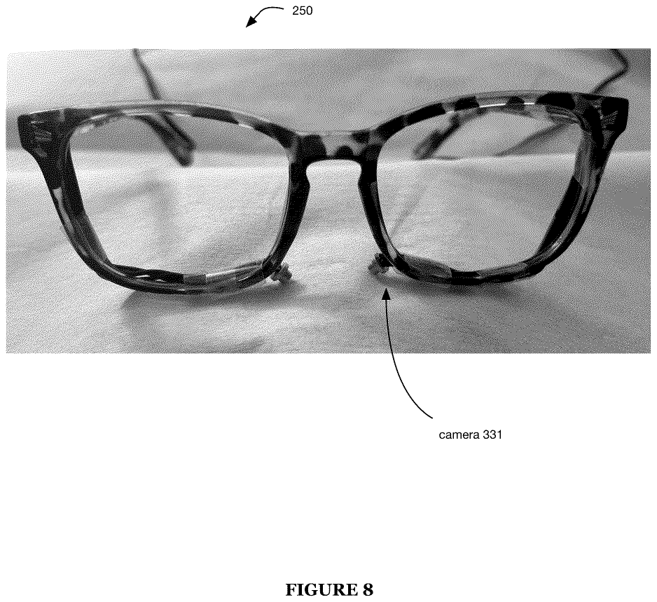

In a second variant, the housing 200 can include a set of glasses 250 (e.g., example shown in FIG. 8). The glasses can include: lenses, a frame, a set of glasses elements, and/or any other components.

The frame can include a left and right lens aperture (e.g., rims; defined by wire or polymer), a bridge connecting the lens apertures, optional nose pads arranged on the bridge and/or the proximal (e.g., inner) edge of the lens apertures, temple arms connected to the lens apertures by a set of hinges, and/or any other frame components. The temple arms can include an elongated body extending rearward, a curved tip with a curved body that wraps over the ear and a downstem that extends behind the ear (e.g., postauricular stem), an optional preauricular component (e.g., preauricular stem) that extends downward from an intermediate point on the elongated body, and/or any other temple arm components.

The set of glasses elements can include a set of sensors, a processing system, a power supply, a set of user inputs, and/or any other glasses elements. The set of glasses elements can be arranged on an edge of the lens apertures opposite from the nose bridge, proximal a hinge connecting the temple arms to the lens apertures, on a temple arm, on a bridge connecting the lens apertures, and/or otherwise arranged. The set of glasses elements can be mounted interior to the glasses housing, on a surface of the housing, etc.

However, the housing 200 can define any other suitable form factor.

However, the housing 200 may be otherwise configured.

### 3.2 Sensors

The set of sensors 300 functions to sample measurements of the speech articulators, user gestures, and/or any other suitable measurements. The sampled measurements can be used to: determine the articulator parameters, predict the user's speech (e.g., silent speech, spoken speech, etc.), identify a user instruction, and/or otherwise be used.

The set of sensors 300 are preferably noninvasive sensors (e.g., remote from the speech articulator), but can alternatively be colocalized, mounted to, and/or otherwise coupled to the speech articulator. The sensors are preferably not located within any user cavities (e.g., oral cavity, nasal cavity, etc.), but can alternatively be located in a user cavity. The sensors are preferably arranged on a surface of the user (e.g., on the skin, etc.), but can additionally or alternatively be retained offset from the user (e.g., by a gap of a predetermined distance) and/or otherwise retained relative to the user. The sensors can be located exterior to the housing, interior to the housing, flush with the housing, and/or any other location. The set of sensors 300 is preferably retained in a predetermined position relative to the user by the housing, but can additionally or alternatively be retained relative to the user by any other component.

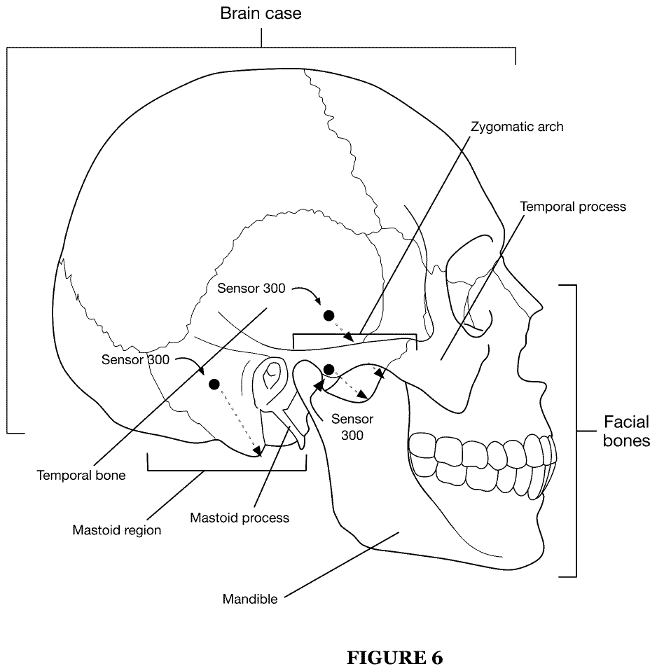

The set of sensors 300 preferably retains the sensors at or near (e.g., within 1 cm, 2 cm, 3 cm, 4 cm, 5 cm, 10 cm, etc. of the region) one or more predetermined regions of the user (e.g., as shown in FIG. 6), but can alternatively retain the sensors at any other region of the user. The predetermined regions can include: the region near the tragus (e.g., preauricular, in front of the ear, pretragal region, etc.), the retroauricular region (e.g., postauricular area, below the ear, behind the earlobe, etc.), a region inferior to the mastoid process of the temporal bone, supriauricular region, infra-auricular region, superior temporal line, the temporal process of the zygomatic bone, on or along the zygomatic arch (e.g., cheekbone, posterior root, the anterior root, etc.), below and/or above the zygomatic arch, on or along the suprazygomatic and/or infrazygomatic regions (e.g., in a cavity defined in these regions), on or along the temporal region of the craniofacial structure (e.g., the lateral aspect of the skull, located on either side of the head between the forehead and ear, bounded superiorly by the temporal line and inferiorly by the zygomatic arch, etc.), the nasofacial region (e.g., the superior nasal bridge, the infraorbital areas, etc.), the mastoid region (e.g., the mastoid region, the retromastoid process, the post auricular region, the mastoid area, etc.), the occipital bone, on or along the mandibular curve, the suprameatal triangle (e.g., Macewen's triangle), the superior longitudinal, inferior longitudinal, transverse, and vertical tongue muscles, the genioglossus, hyoglossus, styloglossus, and palatoglossus muscles, the auricular muscles, the temporalis muscle, the masseter, the neck, the collarbone, the cheek, the temple, the jaw, the mastoid, around the zygomatic bone or arch, and/or any other predetermined region.

In an example, the regions can be aligned with one or more fossa, foramina or canals (e.g., cavities through the skull), and/or other gaps or cavities through the skull. Examples of foramina that the sensors can be aligned with can include: the external acoustic meatus, temporal fossa, infratemporal fossa, the external auditory foramen, the foramen ovale, the foramen spinosum, the stylomastoid foramen, the petrotympanic fissure, the foramen rotundum, the internal acoustic meatus, the carotid canal, the jugular foramen, the foramen lacerum, the infraorbital foramen, and/or any other foramina.

In an example, the selected foramina can correspond to regions with minimal hair. The sensors are preferably arranged at a hairless region of the user (e.g., region with less than a threshold hair density, a region with sparse hair coverage, vellus-dominant region, sparsely haired region, etc.), but can alternatively be arranged at a glabrous (e.g., bald) region of the user, a hairy region of the user, and/or at any other location.

The set of sensors 300 can measure speech articulator parameters using: acoustic coupling, differences in acoustic impedance, motion data (e.g., landmark motion), signal reflection, transmittance, vibration coupling and/or vibration transmission (e.g., that measures how vibrations or energy applied to the skull propagates through the skull in the presence of articular movement), bioelectrical signals (e.g., muscle activation, brain activation, etc.), other biomechanical signals, and/or other biophysical signals.

The speech signals sampled by the set of sensors 300 are preferably used to determine speech (e.g., infer linguistic units), but can alternatively be otherwise used. The speech signals sampled by the set of sensors can be directly used to infer linguistic units (e.g., speech); be used to determine the speech articulator parameters (e.g., pose, configuration, curvature, etc.) which are then used to infer linguistic units; and/or otherwise used. The speech signals can include biophysical signals such as distance, motion of tissues, electrical activity, and/or any other physical properties of biological structures. The speech signals can originate from a measurement region corresponding to a physical region of the user (e.g., a measurement region), but can alternatively originate from any other source.

The sensors can be active (e.g., emit energy toward a target and measure the response) or passive (e.g., measure a signal without emitting energy into the environment).

The active sensors (e.g., sensors with transmitters, sensors with emitters, etc.) are preferably arranged such that the resultant signal path (e.g., radiation pattern) passes through the head (e.g., soft tissue, bone), but can alternatively pass through the neck (e.g., the larynx, throat, etc.) or through any other suitable accessory body part. The signal path can exclude the volume outside the user (e.g., be wholly contained within the user's tissues and/or cavities; exclude the volume outside the head; etc.), include volumes outside the user (e.g., due to signal leakage; include predetermined volumes outside the user, such as the user's lips, region posterior the mouth, region under the bottom of the jaw, etc.), include one or more predetermined volumes inside the head, and/or be otherwise configured. The signal path is preferably transcutaneous, but can alternatively define another path.

In a first example, a sensor's emission and/or return path (e.g., acoustic path) extends through a gap in the skull toward the oral cavity (e.g., through a gap above the zygomatic arch, below the zygomatic arch, between the zygomatic arch and a mandible, etc.). In a specific example, the sensor's path (e.g., ultrasound sensor's acoustic path, RF sensor's path, etc.) traverses oral soft tissue (e.g., buccal tissues, temple tissues, etc.). The emission path can pass: through the oral cavity, stay in the tissue and traverse around the oral cavity (e.g., pass through the cheek, jaw, then the other cheek; always pass through soft tissue; never pass through the oral cavity itself), and/or follow any other path.

In a second example, the sensor's (e.g., RF sensor's) emission and/or return path extends through a bony region of the skull toward the oral cavity.

In a third example, the sensor (e.g., ultrasound sensor's) emission and/or return path can travel under the jaw to and/or from the left and right ears (e.g., in a U-shaped path; path through the cheek, jaw, then other cheek, etc.). In a specific example, disturbance of the ultrasound field induced by articulator (e.g., jaw, tongue, muscle, etc.) movement can be detected and interpreted into speech.

The signal path can target the tongue, lips, jaw, cheeks, hard vocal tract (e.g., hard palate, etc.), larynx, vocal cords, any other speech articulator, and/or any other physiological structure (e.g., “measurement region”). However, the signal path can be otherwise configured.

Examples of sensors that the system can use include: an active imaging sensor or active ranging sensor; a sonar sensor; a radio frequency (RF) sensors 320; an optical sensors 330; a mechanical state sensor; a kinematic sensors 340; an electromagnetic sensors 350; and an audio sensors 360; however, any other set of sensors can be used.

In a first specific example, the set of sensors can include an electromyography (EMG) sensor. In a second specific example, the set of sensors can include a set of RF sensors mounted to the postauricular downstem and directed toward the mastoid process (e.g., to measure speech articulator muscle activations). In a third specific example, the set of sensors can include an ultrasound sensor mounted to the preauricular downstem and aligned with the fossa above and below the zygomatic arch, respectively (e.g., such that the ultrasound sensors has a line of sight to speech articulators in the oral cavity). In variants, EMG sensor 321 depicted in FIG. 4 can be replaced with other sensor types, such as RF sensors or ultrasound sensors.

The active imaging sensor or active ranging sensor functions to sample biomechanical measurements of the user. Examples of active imaging and/or ranging sensors that can be used can include an ultrasound sensor 311, structured light sensor, time of flight sensor, and/or any other sensor. The system can include one or more modalities of active imaging and/or ranging sensors. The system can include one or more active imaging and/or ranging sensors.

For example, the ultrasound sensor 311 functions to sample ultrasound measurements of the articulators. The ultrasound sensor 311 can be a contact ultrasound sensor, airborne ultrasound sensor, and/or any other ultrasound sensor. The ultrasound sensor can be a capacitive micromachined ultrasonic transducers (CMUT), piezoelectric micromachined ultrasonic transducer (PMUT), flexural ultrasound transducer (FUT), and/or any other ultrasonic transducer. In a variant, the flexural ultrasound transducer (FUT) can operate at less than 60 kHz (e.g., 55 kHz, 50 kHz, etc.). Alternatively, the FUT can operate between 100 kHz and 50 MHz (e.g., below 20 MHz, 10 MHz, 1 MHz, etc.), and/or at any other frequency.

The ultrasound sensor can be a single-element transducer (e.g., that functions as both the transmitter and the receiver), an array of transducers (e.g., linear array, curvilinear or convex array, phased array, annular array, 1D array, 2.5D array, 2D array, etc.), a set of capacitive micromachined ultrasonic transducers (CMUTs), a set of piezoelectric micromachined ultrasonic transducers (PMUTs), an ultrasound probe, a set of transceiver pairs (e.g., with separate transmitter and receiver elements, etc.), an ultrasound package, and/or any other ultrasound sensor. The transmitter of a transceiver pair is preferably arranged opposing the paired receiver across the user's skull (e.g., wherein the transmitter is arranged on the left side of the system and the receiver is arranged on the right or vice versa), but can alternatively be arranged on the same side of the user's skull. The ultrasound sensor transmitters and receivers can be paired 1:1, 1: N, N:1, and/or paired with any other cardinality, respectively.

The ultrasound sensor 311 can additionally and/or alternatively include acoustic matching layers, backing material/damping layer, lens (for beam shaping), coupling medium, and/or any other housing and/or coupling structure. The coupling medium can include gel, water/immersion, solid coupling pads, polished solid surface, and/or any other coupling medium.

The ultrasound sensor 311 can additionally and/or alternatively include pulser/driver circuits, a T/R switch (e.g., for transmit/receive isolation), preamplifiers, beamforming ASICs, ADC/digitizers, and/or any other electronic components.

The ultrasound sensor 311 can be operable in A-mode (amplitude vs depth), B-mode (2D brightness imaging), M-mode (motion vs time), 3D/4D imaging (using 2D arrays), one or more doppler modes, and/or any other imaging mode. The one or more doppler modes can include continuous-wave (CW) (e.g., for velocity measurement, deeper tissue penetration, etc.), pulsed-wave (PW), color doppler, power doppler, frequency modulated continuous wave (FMCW) (e.g., to simultaneously measure range via frequency difference, velocity via doppler shift, etc.), and/or any other doppler modes.

The operation modes can use pulsed excitation, continuous-wave excitation, chirp/coded excitation, burst pulses with controlled duty cycle, and/or any other excitation waveform.

The ultrasound sensor 311 can additionally and/or alternatively be operable in time-of-flight (TOF) distance measurement mode, echo-ranging/pulse-echo sensing, thickness measurement mode, material characterization mode, ultrasound elastography mode (strain or shear-wave), and/or any other sensing mode. The material characterization mode can use acoustic impedance, attenuation, speed of sound, and/or any other techniques.

The ultrasound sensor 311 can use fixed focus, dynamic receive focusing, electronic steering (e.g., based on a set of kinematic system measurements, IMU measurements, etc.), synthetic aperture, and/or any other beamforming approach.

In examples, the acoustic field can be formed by adjusting (e.g., by adjusting transmission parameters) the generated beam profile, near field/far field, focusing, steering (phasing), side lobes and grating lobes, and/or any other field parameter.

The ultrasound sensor 311 can use continuous wave, pulsed wave, doppler, FMCW (Frequency modulated continuous wave), chirp-coded, pulse-echo, any other wave, and/or any other waves.

In a first variant, FMCW can be used to transmit a signal that increases (e.g., linearly, exponentially, hyperbolically, logarithmically, etc.) in frequency over time. The FMCW signal can reflect off of the tissue with a frequency offset relative to the transmitted signal, and the offset can encode distance, velocity, and/or phase changes (e.g., small motions). Variants of the sensor operation can include direct digital synthesis with a numerically controlled oscillator, PWM-based drivers, a voltage-controlled oscillator, FPGA-based chirp generators, and/or any other sensor operation variant. In an example of the variant, the frequency can increase from 35 kHz to 45 kHz.

In a second variant, the ultrasound sensor can be controlled using pulsed waveforms. The variant can include transmitting a single frequency continuous wave that is turned on and off. In the variant, a Hilbert transform can be applied to extract a magnitude envelope showing three regions: the initial delay before the wave arrives; a transient region where path geometry strongly influences the waveform; and a steady-state region where articulator influence diminishes. In the variant, articulator movement affects which signal paths are altered, when in the transient region the perturbation appears, the temporal signature of the magnitude envelope, and/or which frequencies and/or phases are modulated.

The signal processing methods that can be used can include noise removal, filtering, fast Fourier transform (FFT) (e.g., to extract distance), signal differences (e.g., computing the difference between time-adjacent ultrasound signals), short time Fourier transform (STFT), envelope detection (e.g., Hilbert transform), phase unwrapping, cross correlation, autocorrelation, convolution, correlation across channels (e.g., coherence of phase, relative time of arrival, etc.), and/or any other signal processing methods.

In variants, the ultrasound sensor 311 can be operated at 35 kHz, 40 kHz, 45 kHz, 63 kHz, 100 kHz, 160 kHz, 250 kHz, 300 kHz, at any range defined therebetween, at above 300 kHz, below 40 kHz, and/or any other frequency. In an example of the variant, the ultrasound sensors can be used to directly measure articulator movement, such as tongue movement, lip movement, and/or jaw movement (e.g., through acoustic coupling with the tissue). In an illustrative example, the ultrasound sensors can detect both direct tongue motion and the muscles controlling tongue movement through the use of FMCW (Frequency Modulated Continuous Wave) ultrasound operating in the 20 kHz-20 MHz range (e.g., between 35-45 kHz, 20 kHz-60 kHz, 100 kHz-200 kHz, 300 kHz-500 kHz, 30 kHz-500 kHz, 40 kHz-400 kHz; lower than 20 kHz, 30 kHz, 50 kHz, 100 kHz, 200 kHz, 300 kHz, 500 kHz, 1 MHz, 2 MHz, 3 MHz, 5 MHz, 10 MHz, 20 MHz, a range defined therebetween; etc.). In this example, the ultrasound sensors can generate: raw return signals (e.g., RF echoes, envelope detection, I/Q demodulated signals, phase and amplitude information, etc.), images, depth measurements (e.g., from time of flight measurements), impedance measurements (e.g., from received amplitude), motion (e.g., from phase shifts), velocity (e.g., from doppler shift), scattering properties (e.g., from echo shape), and/or any other properties.

In examples, ultrasound images (e.g., a 2D image; 2D image associated with depth for one or more pixels; 2D image associated with time or movement for one or more pixels; 3D image; etc.) can be generated using scan conversion, B-mode pixel mapping, frame assembly, color flow overlay (Doppler), and/or any other image generation method.

In a specific example, the ultrasound sensors can sample articulator parameters by transmitting a waveform, creating an acoustic field in the oral cavity and/or in the oral soft tissues using the transmitted waveform, optionally scanning through different regions of the oral cavity and/or oral soft tissues, sampling returns at the receiver, optionally generating an ultrasound image from the set of returns, and/or optionally extracting articulator parameters from the measurements. The waveform can include a short pulse, chirp, FMCW, CW tone, and/or any other waveform. The parameters of the waveform can include a center frequency, a fractional bandwidth, a pulse repetition frequency (PRF)/frame rate, and/or any other parameters. The center frequency can be between 3-7 MHz or any range or value therebetween. The center frequency can alternatively be higher or lower than 3-7 MHz. The fractional bandwidth can be between 50-100% or any range or value therebetween. The pulse repetition frequency (PRF)/frame rate can be between 50-200 fps or any range or value therebetween. The pulse repetition frequency (PRF)/frame rate can alternatively be higher or lower than 50-200 fps. The acoustic field can include a dynamic acoustic field, a standing acoustic field, and/or any other acoustic field. Scanning through different regions of the oral cavity can use beamforming, rasterization, sector-based scanning, and/or any other scanning method. The returns can include reflected returns, channel RF data, beamformed RF data, envelope data, IQ demodulated data, and/or any other returns, wherein the returns can be sampled per-element, per-beam, temporally, and/or otherwise sampled. The sampling frequency can be between 20-40 MHz for 3-7 MHz probes or any range or value therebetween. The beamformed lines can be 128 with lateral spacing of between 0.3-0.6 mm or any range or value therebetween (e.g., depending on the depth, etc.).

The articulator parameters can be extracted from raw ultrasound measurements and/or from ultrasound images. In a first variant, the articulator parameters can be extracted from raw ultrasound measurements (e.g., the returns). In an example of this variant, the surface geometry can be extracted from time of flight measurements (e.g., based on the high-impedance mismatch), tongue-surface depth can be extracted along each scanning line, a Kasai estimator or autocorrelation can be used to extract the velocity and/or micromovements from doppler measurements, and/or otherwise extracted. In examples, the articulator parameters can be predicted using a neural network, wherein the raw measurements are passed to the neural network, optionally alongside the ultrasound sensor pose, head pose, and/or other data.

In a second variant, the articulator parameters can be extracted from ultrasound images (e.g., B-mode images). The articulator parameters can be extracted using computer vision methods (e.g., peak intensity, canny edge detection, contour models, object segmentation, etc.), articulator kinematics can be extracted from image sequences (e.g., using optical flow, neural networks, etc.), the articulator parameters can be predicted using a trained neural network, and/or other extraction methods. The ultrasound images can depict both the articulator of interest (e.g., soft palate, tongue, etc.) and a reference structure (e.g., hard palate, teeth, jaw, etc.), wherein the reference structure can be used as a reference point for articulator parameter determination. The reference structure can be a hard vocal tract structure, a bone, and/or any other structure.

The ultrasound sensors are preferably placed near the zygomatic arch and/or tragus areas to access viewing windows (e.g., foramina) through the skull to the articulators, but can alternatively be arranged proximal the mastoid (e.g., on, behind, in front, above, below, etc.), at a postauricular region, or be otherwise arranged. In a specific example, the ultrasound sensors can be arranged anterior the tragus of the user. In a second specific example, the ultrasound sensors can straddle the zygomatic arch (e.g., be arranged above and below the zygomatic arch). The upper and lower ultrasound sensors can be: different components of a transmitter pair, separate transmitter pairs, separate ultrasound arrays, part of the same ultrasound array, and/or otherwise related. The upper and lower ultrasound sensors can sample the same or different articulator and/or physiological structure.

The ultrasound sensor 311 is preferably oriented perpendicular to the skin surface, but can alternatively be arranged at an angle to the skin surface or otherwise oriented. When the system includes multiple ultrasound sensors, the ultrasound sensors are preferably collocated and substantially vertically aligned relative to each other (e.g., separated by a few millimeters of spacing), but can be angled relative to each other (e.g., one is vertical relative to a gravity vector while the other is at an angle to vertical, etc.), or otherwise arranged.

However, the ultrasound sensor 311 may be otherwise configured.

The sonar sensor functions to sample sonar measurements of the articulators. The sonar sensor can measure distance (e.g., to cheek, to lips, to jaw, etc.) using acoustic reflection, transmission, and/or any other methods. The sonar sensor can measure motion (e.g., velocity, vibration, etc.) using frequency shift, or any other suitable method. The sonar sensor can be arranged at a predetermined region (e.g., preauricular pill, postauricular pill, anterior the face, proximal the temples, etc.). The sonar sensor can operate between 20 kHz and 100 kHz, or any value therebetween. The transducers can propagate signal through air, or any other appropriate medium.

However, the sonar sensor may be otherwise configured.

The radio frequency sensors 320 (RF sensors) function to sample radio frequency measurements of the articulators. In examples, the radio frequency sensors can include radar, doppler motion sensors, time of flight, microwave sensors, mmWave sensors, Terahertz sensors, UWB, and/or any other RF sensors. The radio frequency (RF) sensors 320 can include continuous wave radar, frequency-modulated continuous-wave radar, pulsed radar, and/or any other radar. The radio frequency sensors 320 can generate radiation patterns, focused beams, dynamic beams, and/or any other beams. The radiation patterns of the radio frequency (RF) sensors 320 can be time-varying, static, steerable, modulated, and/or any other pattern type. The radio frequency (RF) sensors 320 can be coherent or noncoherent, and/or have any other cohesion. The radio frequency (RF) sensors 320 can be short-range (e.g., up to several meters), long range (e.g., up to kilometers), and/or have any other range. The antenna of the radio frequency (RF) sensors 320 can be monostatic, bistatic, multistatic, and/or have any other geometry. The radio frequency (RF) sensors 320 can sample measurements using frequencies between 100 MHz to 100 GHz at any range defined therebetween, above 100 GHz, below 1 GHz, and/or any other frequencies. The radio frequency (RF) sensors 320 can be used to measure muscle movements, directly measure articulator movements, distance, and/or otherwise used. In variants, RF sensors (e.g., operating at millimeter wave frequencies) can be preferred for measuring muscular activity, since RF can provide higher spatial resolution than ultrasound. However, the RF sensors can also be used to detect articulator movement (e.g., when used at lower frequencies, etc.). However, RF sensors can be used to measure any other suitable physiological parameter. The received RF signal data can include RF signals modulated (e.g., by frequency, phase, amplitude, multipath, etc.) by a speech articulator in the signal path. Alternatively, the received RF signal data can include RF signals modulated by any part of the user's body (e.g., hands, face, neck, etc.), an accessory, or any other suitable structure.

The RF sensor 320 is preferably positioned behind the ear, but can alternatively be located near the cheek or temple area. In a first example, the RF sensor can be arranged behind the earlobe and above the mastoid process. In a second example, the RF sensor can be arranged above the zygomatic arch. In a third example, the RF sensor can be arranged below the zygomatic arch.

The RF sensor can include: a set of transmitters, a set of receivers, a transceiver, and/or be otherwise configured. In examples, an RF sensor can include a transmitter-receiver pair. The RF sensor can include one transmitter paired with multiple receivers (e.g., 3 receivers, 2 receivers, etc.), multiple transmitters paired with a single receiver, a single transmitter paired with a single receiver, and/or with any other suitable cardinality. The transmitter and receiver(s) are preferably collocated (e.g., on the same chip), but can alternatively be arranged on opposing sides of the user's skull or otherwise arranged. Alternatively, the RF sensor can include a set of arrays (e.g., phased arrays, etc.), and/or be otherwise configured.

In a specific example, the RF sensors can sample articulator parameters by transmitting a waveform; creating a standing field in the oral cavity, larynx, jaw, and/or other articulators; sampling changes in the standing field; and/or optionally extracting articulator parameters (e.g., motion, position) from the measurements. The waveform can include short pulse, chirp, continuous waves, multi-frequency continuous waves, frequency hopping continuous waves, amplitude-modulated continuous waves, phase-modulated continuous waves, and/or frequency-modulated continuous waves. The center frequency can be between 3-75 GHz, or any range or value therebetween. The center frequency can alternatively be higher or lower than 3-75 Ghz. The fractional bandwidth can be between 0-5% for narrowband CW signaling, between 1-20% for FMCW or multi-tone signaling, between 20-100% for UWB/impulse waveforms, or any other range or value therebetween. The return signals can include amplitude returns, phase returns, quadrature (IQ) samples, frequency-dependent impedance responses, multi-tone response vectors, FMCW beat signals, and/or any other RF return, wherein the returns can be sampled per-element, per-tone, per-chirp, temporally, and/or otherwise sampled. The sampling frequency (e.g., ADC rate) can be between 100 kS/s-10 MS/s or any range or value therebetween depending on the waveform, bandwidth, and motion bandwidth. However, the radio frequency (RF) sensors 320 may be otherwise configured.

The optical sensors 330 function to sample optical measurements of the articulators and/or environment. The optical sensors 330 can be imaging or non-imaging. The optical sensors 330 can measure articulator parameters using reflection, transmission (e.g., optical wave transmission through tissue), interference (e.g., interference generated between reflected and transmitted light), and/or any other methods. The optical sensors 330 can include: optical odometer, time of flight 332 (e.g., optical time of flight), cameras 331 (e.g., RGB, NIR, UV, multispectral, stereo, etc.), IR reflectometry, structured light, a single-photon avalanche diode (SPAD), and/or any other optical sensors. The articulator parameter value can be extracted from optical transmission variations (e.g., through tissue), interference patterns, transit time for a light pulse, phase of reflected light, the articulator depicted in a resultant image, distortions in projected patterns, and/or any other optical measurement techniques. The optical sensors 330 are preferably positioned in front of the ear (e.g., on a preauricular component), but can alternatively be positioned behind the ear and/or on any portion of the housing.

The optical sensors 330 can be used to measure the lip positions, the cheek positions, infer the subcutaneous muscle positions, and/or measure other articulators. The optical sensors 330 can additionally or alternatively measure the ambient environment, head movement, head position, pose, and/or any other target. In a first example, the optical sensors can include a time-of-flight camera positioned near the ear, oriented to image the cheek surface (e.g., by monitoring changes in depth). The camera can measure cheek deformation and ripples caused by lip and articulator movements. In a second example, the optical sensors can include a set of cameras positioned above the zygomatic bone and directed downward to image the cheek and lips.

However, the optical sensors 330 may be otherwise configured.

The mechanical state sensors function to measure forces, deformation, or dynamic excitation. The mechanical state sensors can include force sensors, stress sensors, strain gauges, piezo elements. The mechanical state sensors can be arranged on the housing, within the housing, and/or otherwise located. In a variant, the mechanical sensors can measure housing deformation. In an example of the variant, the system can trigger an action when a measured mechanical state surpasses a threshold. However, the mechanical state sensors may be otherwise configured.

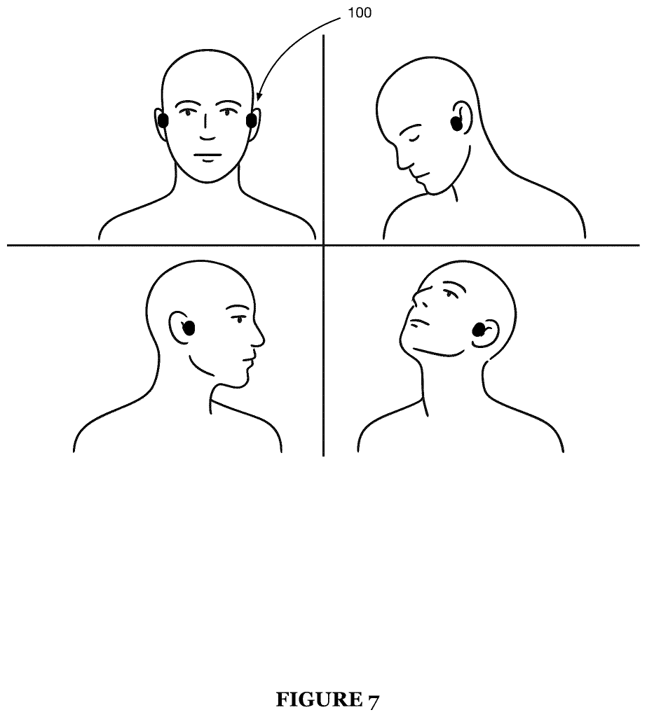

The kinematic sensors 340 function to measure motion, displacement, velocity, acceleration, pose, force, strain, vibration frequency, vibration amplitude, and/or any other suitable parameters. The kinematic sensors 340 can include an accelerometer, gyroscope, IMU, vibration sensors, and/or any other sensors. The kinematic sensors 340 can be offset from or contact the user. The sampled kinematic measurements from the kinematic sensors 340 can be used to infer articulator parameters from physical changes (e.g., macro changes in head or user movement, micro changes in the skin, etc.), be used to weight sensor measurements, be used to detect trigger events, be used as a conditioning input (e.g., to indicate head pose, system pose relative to the user's head, etc.), and/or be otherwise used. In a first example, the physical changes can include head positions and/or postures (e.g., neck bent, neck twisted, head tilted, etc.), and/or other macro physical changes. An example is shown in FIG. 7. However, any other set of sensors (e.g., cameras, optical sensors, dead reckoning sensors, magnetic field sensors, etc.) can be used as head pose sensors. The head pose sensors are preferably a secondary set of sensors to those measuring the articulators, but can alternatively be the articulator sensors. In a second example, articulator parameters can be inferred given head movement during speech (e.g., nodding, shaking, twisting, vibration, etc.).

The kinematic sensors 340 can be arranged: preauricularly, postauricularly, posterior the head, anterior the head, proximal the neck, superior the head, proximal the face, and/or at any other predetermined region of the user.

However, the kinematic sensors 340 may be otherwise configured.

The electromagnetic sensors 350 function to measure electromagnetic measurements of the articulators. The electromagnetic sensors 350 can include EMG sensors 321, capacitors, inductive coils, magnetometers, impedance sensors, electroencephalography (EEG) sensors, biosignal sensors, and/or any other sensors. The electromagnetic sensors 350 can be arranged along regions of the housing contacting the user. The regions of the housing contacting the user can be in contact with skin, hair, and/or any other body parts. The electromagnetic sensor can be a single-ended electrode, a differential electrode pair (e.g., bipolar EMG), a tri-polar or double-differential EMG arrangement, a monopolar EEG-type arrangement with a distant reference, a high-density electrode array (e.g., 4×4, 8×8, 16×16, etc.), a set of flexible printed electrodes, a textile-integrated electrode array, a dry-electrode assembly, and/or any other electrode or electromagnetic sensing structure. The active and reference electrodes can be paired 1:1, 1:N, N:1, and/or with any other cardinality. The electromagnetic sensors (and/or any other sensor) can be arranged proximal the masseter, temporalis, orbicularis oris, mentalis, buccinator, submental complex, zygomaticus major, mastoid, orbicularis oris, orbicularis oculi, corrugator supercilii, frontalis, risorius, predetermined region of the brain (e.g., C3, C4, F3, F4, P3, P4, etc.), and/or in any other location. In a variant, the electromagnetic sensor can include a reference sensor distal from a sensor measuring an articulator and/or on a non-muscular (e.g., bony, electrically quiet) area of the user (e.g., behind the ear, proximal the mastoid process, on the forehead, on the earlobe, on the back of the neck, on the bridge of the nose, on the kneecap, etc.). The electromagnetic sensors can be placed parallel to the muscle fiber direction, but alternatively can be placed in any other direction.

The electromagnetic sensor 350 can additionally and/or alternatively include shielding layers, isolation foam, conductive adhesive, compliant interfaces, impedance-matched electrode coatings, hydrogel layers, dielectric coupling pads, and/or any other support or coupling structure. The electromagnetic sensors can optionally include driven-right-leg (DRL) electrodes, bias electrodes, or guard traces for noise suppression. The coupling interface can include gel, hydrogel, saline solution, conductive polymer, dry-contact structures (e.g., metal, conductive fabric, carbon-loaded silicone), micro-spike or micro-needle arrays, capacitive plates separated from the skin by a dielectric layer, and/or any other coupling interface.

The electromagnetic sensors 350 can determine articulator parameter values from changes in impedance, current, potential, and/or other electromagnetic attributes. In a first example, one or more articulators (e.g., the tongue, the soft palette, etc.) can act as an electric dipole, wherein movement of the articulator within an applied electric field can create current and potential changes in the surrounding tissues that are measured to infer the articulator parameter value. In a second example, one or more articulators (e.g., the tongue, etc.) can act as a shunt and shunt current away from the scalp or other skin region of the user. Changes in the skin current can be used to determine the articulator parameter value. The electromagnetic sensor can have a bandwidth between 10 Hz to 10 kHz, or any value and/or range therebetween. The data acquisition module for the electromagnetic sensor can include a common-mode rejection ratio (CMRR) between 50-150 dB, an input impedance above 1 Mega Ohm, and/or any combination of electrical characteristics.

The electromagnetic sensor 350 can be operable in EMG mode (e.g., surface EMG, intramuscular EMG), EEG mode, ECoG-like mode (e.g., high-density scalp potentials), impedance-based sensing mode (e.g., EIT, bioimpedance spectroscopy), magnetomyography (MMG) mode, capacitive biopotential mode, electro-oculography (EOG) mode, galvanic skin response (GSR) mode, and/or any other electromagnetic measurement mode. The EMG mode can include detection of motor unit action potentials (MUAPs), EMG envelopes, rectified EMG, spectral EMG, and/or any other EMG mode. The EEG mode can include detection of alpha, beta, theta, delta, gamma, slow cortical potentials, event-related potentials, and/or any other EEG modes.

The operation mode of the electromagnetic sensor can include continuous sampling, pulsed sampling, burst-mode sampling, duty-cycled sampling, triggered sampling (e.g., threshold-triggered), synchronous sampling with other sensors (e.g., IMU, ultrasound), and/or any other temporal sampling mode. The electromagnetic sensor can additionally support impedance spectroscopy, wherein a drive current is injected at one or more frequencies (e.g., between 10 Hz and 1 MHz, or any range or value therebetween) and the resulting voltage response is measured to infer tissue properties.

In variants, the electromagnetic sensors 350 can be used to directly measure articulator muscle activation (e.g., masseter activation for jaw position, orbicularis oris activation for lip rounding/protrusion, submental activation for tongue elevation, zygomaticus activation for cheek/tongue coupling, etc.), brain activity related to articulator control (e.g., EEG from frontal or temporal regions), tissue impedance changes associated with articulator movement, and/or any other electromagnetic correlates of articulation. The electromagnetic sensors can detect raw potentials, EMG envelopes, EEG band-power changes, impedance magnitude and phase, magnetic field fluctuations, and/or any other signals associated with articulator movement.

In an illustrative example, a first electromagnetic sensor is arranged below the zygomatic arch in the auricular region, and a second electromagnetic sensor is arranged in a postauricular region (e.g., electrically quiet) of the user. In the example, the first and second electromagnetic sensor are EMG electrodes with dry coupling to a skin surface. The second electromagnetic sensor can be used as a reference for the measurements collected at the first electromagnetic sensor. In the example, the housing biases the electromagnetic sensors against the skin of a user. The measurements collected at the first and second electromagnetic sensors can represent subvocal speech parameters and can be used to infer linguistic units. In a specific example, the first and second electromagnetic sensors are EMG sensors.

However, the electromagnetic sensors 350 may be otherwise configured.

The audio sensors 360 function to measure acoustic measurements of the articulators and/or environment. In an example, the audio sensors 360 can measure a user's speech, environmental noise, volume, and/or any other audio characteristics. The audio sensors 360 can include a microphone 361, a transducer, and/or any other audio sensing components. The audio sensors 360 can be air conduction, bone conduction, soft tissue conduction, and/or any other conduction. The audio sensors 360 can be oriented toward the user's mouth, throat, the environment, and/or any other location.

The audio sensors 360 can be arranged in front of the ear (e.g., preauricular), behind the ear (e.g., postauricular, proximal the mastoid process), proximal the temple, in contact with the throat, and/or in contact with the skin (e.g., of the head, the neck, the chest, etc.), and/or in any other location.

However, the audio sensors 360 may be otherwise configured.

The system can include one or more of each sensor modality. Different instances of a sensor modality and/or different sensor modalities can actively measure data concurrently, contemporaneously, sequentially, asynchronously, in alternation, and/or otherwise measure data. The sensors can be selectively powered, powered all at once, and/or otherwise powered. Signals from different sensor modalities can be input to a model together, separately, or in a combination. The sensor modalities can be interpreted in aggregate, separately, or in a combination. The sensor modality data can be selectively weighted, weighted uniformly, or otherwise fused.

In variants, sensors of the same modality can be operated at different wavelengths and/or frequencies to measure different parameters of the speech articulator. In these variants, the resultant signals can be combined to increase the accuracy and/or confidence of the silent speech prediction and/or can additionally and/or alternatively be otherwise utilized.

In variants of the system with multiple sensors of the same modality, different sensors of the same modality can transmit and/or receive: concurrently, in a predetermined sequence, in alternation, and/or in any other order. In a first example, two ultrasound sensors can operate in an alternating mode wherein one sensor transduces at a time. In a second example, a first ultrasound sensor can transmit while the second ultrasound sensor receives.

In variants of the system with multiple sensors of the same modality, different sensors of the same modality can transmit and/or receive: concurrently, in a predetermined sequence, in alternation, and/or in any other order. The different sensor instances of the same modality can monitor the same or different speech articulator, region of the speech articulator, and/or other physiological structure. In variants of the system with sensors of different modalities, the different sensors can monitor the same or different speech articulator, region thereof, parameter thereof, and/or other physiological structure.

In a first example, the model(s) can jointly process ultrasound and RF data to infer a linguistic unit.

In a second example, the model(s) can independently infer linguistic units from RF and ultrasound data and compare the respective outputs to generate a final determination of the linguistic unit.

Different sensor modalities can have different physiological targets (e.g., monitor different physiological structures), or can share physiological targets.

In a first example, different sensor modalities can have different physiological targets wherein a set of ultrasound can be targeted to the mouth (e.g., inside of the mouth), a set of optical sensors can target the face (e.g., cheek, lip, muscles controlling the lips), and a set of RF sensors can target the jaw.

In a second example, EMG can target facial muscles, and IMU can be used to infer articulator position and head pose.

In a third example, ultrasound can be used to target the mouth, and IMU sensors can be used to infer articulator position and head pose. In a fourth example, RF and ultrasound sensors can both target articulators.

In a fifth example, ultrasound sensors can target the tongue, and RF sensors can target muscles that control articulators.

However, the set of sensors 300 may be otherwise configured. In a first example of the system, a headset can include a housing including a first housing segment located in front of the ear near the tragus and a second housing segment positioned behind the ear (e.g., mounted on the postauricular component). The headset can include a set of sensors arranged in the housing. The headset can include a subset of sensors (e.g., duplicated on one side of the face) or subsets of sensors on the left and a right sides of the face (e.g., a different combination of sensors on either sides of the face). The sensors can be oriented perpendicular to the skin surface and positioned to avoid hair interference by utilizing the natural gap between the ear and hairline. The headset can optionally include forward-facing camera(s) (e.g., mounted to the preauricular component), earbuds, and/or other components. In variants, the headset can optionally include speakers (e.g., open ear speakers, arranged at the top of the preauricular components); a PCB (e.g., arranged in a postauricular component, such as the one mounting the RF sensor or the other one); a battery (e.g., arranged in a postauricular component, such as the one not mounting the RF sensor); a front-facing camera mounted to one or both preauricular components; and/or other components.

In a first specific example of the first example, the set of sensors can include a first EMG sensor arranged in the first housing segment (e.g., preauricular component) and a second EMG sensor arranged in the second housing segment (e.g., postauricular component). In the example, the second EMG sensor can be a reference electrode. In a second specific example of the first example, the first housing segment can straddle the zygomatic arch and include a first EMG sensor above the zygomatic arch and a second EMG sensors below the zygomatic arch. The second specific example can further include a reference electrode arranged behind the ear. In a third specific example of the first example, an RF sensor (e.g., millimeter wave RF sensor; with one transmitter and three receivers, etc.) can be positioned behind the ear (e.g., mounted on the postauricular component). In the specific example, the headset can include a single RF sensor (e.g., on one side of the face) or a left and a right RF sensor. In a fourth specific example of the example, the headset can include two ultrasound sensor pairs located in front of the ear near the tragus and above the zygomatic arch (e.g., mounted on the left and right preauricular components), wherein the transmitter and receiver in each pair can be arranged on opposing sides of the headset. An optional inductive sensor (e.g., an inductive coil) can be arranged behind the ear (e.g., mounted to the same or different postauricular component as the RF sensor). A time-of-flight sensor can optionally be mounted to the preauricular component, and can be oriented to image the cheek area (e.g., oriented lingually toward the buccal region). However, the sensors can be otherwise arranged.

In a second example of the system, a set of earbuds can include a set of sensors positioned around the ear region in a pill-shaped housing located in front of the ear near the tragus. Additional sensors in the set can be positioned behind the ear. A time-of-flight sensor can be optionally integrated into the same housing as the set of sensors The housing connects to a spring-loaded frame that wraps around the ear to maintain proper contact pressure between the sensors and the skin. Alternatively, the sensors can be arranged in the padding of over-the-ear headphones. An example is shown in FIG. 10.

In a first specific example of the second example, the set of sensors includes EMG sensors positioned in front of the ear near the tragus. A second EMG sensor can be arranged in a separate module behind the ear. In a second specific example of the second example, the set of sensors can include EMG sensors embedded in the padding of over-the-ear headphones in contact with the skin. The sensors can be arranged preauricularly between the ear and the hairline with another electrode postauricularly. In a third specific example of the second example, the set of sensors can include an RF sensor in the housing in front of the ear and optionally in the housing positioned behind the ear. In a fourth specific example of the second example, two ultrasound sensors are arranged along a shared axis (e.g., substantially vertically, within several degrees of deviation from vertical, etc.) in the housing located in front of the ear near the tragus, with RF sensors contained in a separate module behind the ear.

In a third example of the system, a pair of glasses (e.g., spectacles, VR headsets, etc.) can include a set of sensors positioned along the temple arms, under the frames to capture lip movements, aligned with the nasal orifice (e.g., to monitor articulators within the oral cavity), behind the ear, and/or at any other location. The sensors detect muscle movements (e.g., lip movement, jaw movements, tongue muscle activity, etc.). The glasses can additionally include a set of optical sensors (e.g., time-of-flight sensors) positioned under the frames or on the arms looking down at the cheek to detect cheek ripples and lip movements, and/or directed inward toward the temple to detect temple movement during lip articulation.

In a first specific example of the third example, the set of sensors include a set of EMG sensors in contact with the skin of the user. The EMG sensors can be arranged near the bottom of the lens frames in contact with a cheek of the user, along the temple arms, and/or on the nose bridge in contact with the nose of the user.

In a second specific example of the third example, the set of sensors include RF sensors operate at millimeter wave frequencies (10-60 GHz). The RF sensors can be positioned along the temple arms, under the frames, and/or aligned with the nasal orifice.

In a third specific example of the third example, the set of sensors include ultrasound sensors. The ultrasound sensors can be arranged under the zygomatic arch and/or near the temple of the user.

However, the system may be otherwise configured.

### 3.3 Processing System

The processing system 400 functions to process sensor signals into a set of linguistic units in a second modality. The processing system 400 can also be used to process auxiliary signals, run a set of models, run a program, communicate with other devices, authenticate a user identity, receive data (e.g., from another device, a remote computer, etc.), and/or otherwise be used.

The processing system can be a local computing system (e.g., located on the device, mounted within the housing, etc.). The processing system can be remote (e.g., remote from the device, offboard the device, a phone or tablet paired with the device, a cloud computing system, an accessory device, etc.). The linguistic unit determined from a set of sensor signals can be a phoneme, a morpheme, a word, a subword, a phrase, a viseme (e.g., visual counterpart of a phoneme; the way a sound looks on the speaker's face, etc.), a token (e.g., defined by training an ML model), and/or any other linguistic unit. The second modality can be text, speech, and/or any other modality.

The processing system 400 can convert sensor signals to the second modality: deterministically, probabilistically (e.g., stochastically), and/or otherwise determined. The sensor signals can be converted to the second modality: in real-or near-real time (e.g., responsive to a signal sampling), iteratively, concurrently, asynchronously, periodically, and/or at any other suitable time. All or portions of the method can be performed automatically, manually, semi-automatically, and/or otherwise performed.

The second modality's values can be computed, looked up, predicted, inferred, and/or otherwise determined from the sensor signals and/or features thereof. The second modality is preferably determined from the set of sensor signals using one or more models (e.g., ML models, probabilistic models, stochastic models, deterministic models, etc.), but can additionally or alternatively be otherwise determined.

In a first variant, the system can sample a set of sensor signals; determine a set of articulator parameter values from the set of sensor signals; optionally map articulator parameter values to a set of linguistic units in the second modality (e.g., generate second modality values, such as text or speech). The articulator parameter values can be predicted, looked up, computed, extracted, and/or otherwise determined from the set of sensor signals. In an example, a 3D tomographic map of the oral cavity can be generated from a set of ultrasound measurements, wherein the tongue position (e.g., the articulator parameter value) can be extracted from the tomographic map. The mapping can be performed using a predetermined mapping (e.g., mapping articulator parameter value permutations to linguistic units; including different articulator positions or kinematics mapped to different linguistic unit values), a lookup table, a set of clusters (e.g., wherein different clusters of articulator parameter values and/or embeddings thereof are associated with different linguistic unit values), a neural network (e.g., a classifier, transformer, etc.), and/or any other mapping approach.

In a second variant, the system can sample a set of sensor signals; optionally determine a set of articulator parameter values from the set of sensor signals; and predict the linguistic units in the second modality (e.g., the second modality values) from sensor signals and/or articulator parameter values using a trained neural network.

In a first embodiment, the system can extract articulator parameters (e.g., tongue pose, etc.) and/or other explicit features from the sensor signals, and predict linguistic units based on the articulator parameter values.

In a second embodiment, the system can feed the sensor signals (e.g., processed or unprocessed) into the neural network, wherein the neural network can embed the sensor signals into a latent space and decode the embeddings into a set of linguistic units. The latent space is preferably not human interpretable (e.g., has no semantic human meaning), but can alternatively be human interpretable (e.g., wherein an embedding index's value has semantic meaning to a human). The latent space is preferably learned through training the model, but can alternatively be human-coded or otherwise determined.

The neural network can include: a transformer, a DNN, a GNN, a GAN, a CNN, an RNN, an LLM, a diffusion model, a classifier, a feature detector, and/or any other suitable neural network architecture. The neural network can be trained on a set of sensor signal-linguistic unit pairs, trained using reinforcement learning, and/or otherwise trained. In an example of the second variant, the neural network can encode the set of signals into one or more latent vectors (e.g., one for each sensor modality, one for multiple sensor modalities, etc.). The latent vectors can be matched to predetermined latent vectors associated with words or phonemes, be used to predict words or phonemes (e.g., using a decoder), and/or otherwise used.

In variants, auxiliary data can be used in addition to the sensor signals to determine the linguistic units (e.g., for deduplication, selecting between similar options, etc.). In variants, the auxiliary data can be sampled by external devices (e.g., user phone, smartwatch, biometric sensors, etc.), received from the user (e.g., as explicit user inputs), and/or otherwise determined.

Examples of auxiliary data that can be used can include images, video, biometric data, biosignals (e.g., heart rate, EEG, EKG, ECG, etc.), audio, temperature, humidity, pressure, kinematics, and/or any other auxiliary data. In a specific example, the sensor signals used to determine speech (e.g., text) excludes biosignals. However, in other examples, the set of sensor signals can include biosignals and/or exclude other sensing modalities.

In an illustrative example, a laptop or smartphone camera (e.g., a remote sensor) can capture lip movements, which can be provided alongside the system measurements (e.g., sampled by local sensors physically contacting the user) to determine the linguistic unit. Camera measurements can be used during training (e.g., wherein the lip movements or other external movements can be used as part of the training or training target data), during inference (e.g., wherein the external movements are used as auxiliary or validation measurements, wherein the measurements are used independent of a wearable device), and/or otherwise used.

In another illustrative example, the auxiliary data can be used to disambiguate or add emphasis to predicted linguistic units (e.g., add a “!” to a sentence when the heart rate exceeds a threshold). This can be particularly useful in silent speech, since vocal inflections and/or other acoustic indicators of disambiguation or emphasis may not be present or detectable.

In a third variant, the system can optionally include a secondary model configured to process contextual signals sampled by auxiliary sensors. The contextual signals can include gestures, the environmental target indicated by the gesture (e.g., portion of a screen, etc.), and/or other signal. Examples of the secondary model that can be used can include: a computer vision model configured to extract features (e.g., embeddings, object detections, object tracks, labels, etc.) from a set of images; a gesture interpretation model configured to extract gestures from a set of kinematic measurements; and/or any other models.

In a specific example, the system can include a CV model configured to infer a user gesture from a video sampled by the front-facing camera, wherein the detected user gesture can be used to operate the system (e.g., switch operation modes, attach the silent speech text to the label for an environmental target identified using the gesture, etc.), and/or otherwise used.

The processing system 400 preferably converts the sensor signals to text (e.g., the second modality), then transforms the text into a third modality, but can additionally or alternatively directly convert the sensor signals to the third modality (e.g., to spoken speech); convert the sensor signals to explicit articulator parameter values (e.g., curvature, acceleration, etc.) then predict the second and/or third modality from the articulator parameter values; and/or otherwise process the sensor signals.

In a first variant, the text can be transformed into spoken speech (e.g., using a virtual speech synthesis module, using a neural network that outputs audio, etc.). In examples, this variant can be used for silent conversations between users.

In a second variant, the text can be used as a prompt or input (e.g., to a model, to a device, to an API endpoint, etc.), wherein an output is generated based on the input. Examples of the output can include interactions with a third-party model (e.g., GPT, Claude, another LLM, etc.), interactions with other devices (e.g., editing a text document, writing an email or note, sending an SMS, commanding a smart device, etc.), and/or other outputs.

The sensor signals can be used to predict the second modality: in a raw form, a processed form, a derivative form (e.g., a timeseries, change over time, statistical measure, etc.), a fused form (e.g., fused with different sensor modalities, etc.), and/or in any other form. The sensor signals are preferably processed in the frequency domain, but can also be processed in the time domain and/or in any other domain. Examples of sensor signal processing methods that can be used can include FFT normalization, filtering, frequency down-conversion, Hilbert transform, weighting, feature extraction (e.g., extracting phase trajectories, envelope modulation, frequency drift, spectral patterns, etc.), sensor fusion (e.g., aggregating combinations of sensors, synchronizing sensor data, handing off sensor data, etc.), processing methods (e.g., performed on raw sensor signals, aggregated sensor signals, separate sensor signals, etc.), and/or any other sensor signal processing methods. FFT normalization can normalize signal amplitudes to account for user-to-user variability (e.g., different head sizes, tissue densities, etc.). Filtering can include frequency, range, spatial, or time domain filtering, bandpass filtering (e.g., preserving any range between 100 kHz to 2 MHz), notch filters (e.g., to remove resonances, vibrations, etc.), and/or other filters. Filters can be fixed or adaptive, and can include analog or digital filters (e.g., FIR, IIR).

The sensor signals can be processed using the processing system, by a dedicated chipset, by a remote computing system, or using any suitable element.

The processing system 400 can optionally include a set of processors 410. The set of processors 410 can include microprocessors, ASICs, GPUs, CPUs, and/or any other computing units.

The processors can run one or more models. The one or more models can be transformer based, but can alternatively have any other suitable architecture (e.g., as discussed above). The models used in the system (e.g., signal interpretation models, text prediction models, speech generation models, etc.) can be generalized (e.g., for multiple users), trained for a specific user, generalized but corrected using a user-specific calibration, and/or otherwise generalized or customized. The model can be trained to infer linguistic units from a silent speech signal, from audio, or from a combination of signal modalities. The model(s) are preferably trained using a data set derived from the same set of sensor modalities as used during inference, but can alternatively be trained using a dataset derived from a different set of sensors as used during inference. The model is preferably trained using the same arrangement (e.g., type, number, position, orientation) of sensors as used during inference, but can alternatively be trained using data derived from a different arrangement of sensors.

The processing system 400 can include memory 420 which functions to store: raw measurements, extracted features, extracted linguistic units, embeddings (e.g., of the measurements), and/or any other information. The memory 420 can include RAM, Flash, ROM, and/or any other memory. The memory 420 can be electrically connected to the set of processors, to a data connector, to the communications system, and/or any other component.

The processing system 400 can include a communication system 430. The communication system 430 can facilitate communication between components of the system and/or communication between the system and external devices. The communication system 430 can be used to transmit data (e.g., raw measurements, articulator parameters, linguistic units, model outputs, etc.) with another device, register the system with another device, and/or otherwise function.

The auxiliary device (e.g., external device) can be another component on the same system (e.g., right system component, etc.), a user device (e.g., smartphone, tablet, etc.), an application running on the user device, an auxiliary device (e.g., local to the user; speaker, smart system, etc.), a remote computing system (e.g., cloud computing system, etc.), and/or any other auxiliary device. In variants, the communication system can send data to an auxiliary device to be processed, interpreted, and/or otherwise manipulated (e.g., over Bluetooth, WiFi, a wired connection, etc.).

The communication system 430 can include a wireless connection, a wired connection (e.g., USB, Ethernet, etc.), and/or any other connection. The wireless connection can include Bluetooth classic, Bluetooth Low Energy (BLE), Wi-Fi Direct, Ultra-Wideband (UWB), cellular (e.g., LTE Direct, 5G sidelink), line-of-sight (e.g., infrared), NFC, and/or any other communication module.

The communication system 430 can be controlled by the processing unit, but can alternatively be otherwise controlled. Data received by the communication system is preferably sent to the processing unit, but can additionally and/or alternatively be otherwise processed. The communication system 430 can include an antenna and/or a chip set, and/or include other components. The antenna can be a planar coil, a closed wire loop, a ferrite-backed loop, a monopole antenna, an inverted-F, meandered dipole, a printed antenna, slot antenna, and/or any other antenna. The chip set can include an RF transceiver, a subscriber identity module (SIM) subsystem, an electronic SIM subsystem, amplifiers (e.g., low-noise amplifiers, pre-amplifiers, etc.), filters, communication protocol interfaces, CPU core, digital signal processor, memory, digital-to-analog converter, analog-to-digital converters, pre-amplifiers, sensor interfaces, and/or any other components.

The antenna and/or chip set is preferably mounted to a different component of the housing than the active sensors (e.g., sensors with emitters), but can additionally or alternatively be mounted to the same component. The communication system preferably operates on a different frequency from the active sensors, but can alternatively operate on the same frequency (e.g., operate interchangeably with the active sensors, be shielded from the active sensors, etc.).

The processing system 400 can include a power system 440. The power system 440 can supply power to the elements of the system. The power system 440 can be used to manage device power provision parameters (e.g., battery management, temperature monitoring, etc.). The power system 440 can include: a battery, power generator, energy harvester (e.g., configured to harvest energy from motion), and/or any other power components. The active components of the system (e.g., processing system, set of sensors, etc.) are preferably electrically connected to and/or powered by the power system 440, but can alternatively be powered by the user device, by an external system, and/or otherwise powered. The power system 440 can supply power from the wearable, from an external pack, from another device, and/or any other source. The power system 440 can include a power management circuit configured to control power delivered to the set of sensors. The power system 440 can supply power via a wired connection, from a battery, through a contact connection, and/or any other connection. The power system 440 can include power connections (e.g., USB-C, thunderbolt, USB-A, etc.). The power connection and communication (e.g., data) connection can share the same connection, or have separate connections.

However, the processing system 400 may be otherwise configured.

### 4. Specific Examples

Specific example 1. A system comprising: a headset comprising: a housing arranged at an auricular region of the user; a set of sensors arranged in the housing, targeting a measurement region of the user, wherein a set of measurements sampled by the set of sensors comprises biophysical signals from the measurement region, and an acoustic speaker arranged in the housing and oriented toward an ear of the user; and a model trained to determine a linguistic unit from a set of subvocal speech signals indicative of parameters of a set of speech articulators of the user, wherein the set of subvocal speech signals comprise biophysical signals sampled using the set of sensors.

Specific example 2. The system of specific example 1, wherein the set of sensors comprises an active sensor.

Specific example 3. The system of specific example 2, wherein a signal path of the active sensor traverses oral soft tissue.

Specific example 4. The system of specific example 2, wherein the active sensor is aligned with a skull gap between a zygomatic arch and a mandible of the user; and oriented toward an oral cavity of the user.

Specific example 5. The system of specific example 1, further comprising an head pose sensor, wherein the model is further trained to account for head position-induced variations in the set of subvocal speech signals using measurements sampled by the head pose sensor.

Specific example 6. The system of specific example 5, wherein the head pose sensor comprises an inertial measurement unit (IMU).

Specific example 7. The system of specific example 1, wherein the set of sensors comprises an electromyography sensor.

Specific example 8. The system of specific example 1, wherein the set of sensors comprises a radio frequency sensor.

Specific example 9. The system of specific example 1, wherein the sensor is an ultrasound sensor.

Specific example 10. A subvocal speech system comprising: a set of sensors, wherein: the set of sensors are configured to transcutaneously measure a set of subvocal speech signals associated with speech articulator motion (e.g., indicative of speech articulator motion, muscle activation associated with speech articulator motion, signals measuring speech articulator motion, etc.), and the set of sensors are arranged within a preauricular housing segment and a postauricular housing segment, wherein: the preauricular housing segment opposes the postauricular housing segment across an ear of a user, and the preauricular housing segment is biased against a preauricular region of the user by a biasing mechanism of the housing; and a processor comprising a model configured to infer a linguistic unit based on the set of subvocal speech signals.

Specific example 11. The subvocal speech system of specific example 10, wherein the set of sensors comprises an electromyography sensor.

Specific example 12. The subvocal speech system of specific example 11, wherein set of sensors comprises a radiofrequency sensor.

Specific example 13. The subvocal speech system of specific example 10, wherein the set of sensors comprises an ultrasound sensor.

Specific example 14. The subvocal speech system of specific example 10, further comprising a front facing camera mounted to the preauricular housing segment and oriented toward an environment of the user.

Specific example 15. The subvocal speech system of specific example 14, wherein the processor further comprises a computer vision model configured to extract a set of user gestures based on images measured by the front facing camera.

Specific example 16. The subvocal speech system of specific example 10, further comprising a time of flight sensor oriented toward a cheek of the user and a mouth of the user.

Specific example 17. The subvocal speech system of specific example 10, further comprising a communication module configured to transmit speech, generated from the linguistic unit, to another user.

Specific example 18. The subvocal speech system of specific example 10, wherein the set of sensors further comprises a microphone; and the processor is configured to switch between a spoken mode and a subvocal speech mode when an ambient volume measured at the microphone exceeding a predetermined threshold.

Specific example 19. The system of specific example 10, wherein the set of sensors comprises an inertial measurement unit.

Specific example 20. The subvocal speech system of specific example 10, wherein a first sensor in the set of sensors is oriented to target a different physiological structure of the user than a second sensor in the set of sensors.

Specific example 21. The system of specific example 1, wherein the sensor is retained on a skin surface of the user with less than a threshold hair density.

Specific example 22. The system of specific example 1, wherein the sensor samples a speech articulator of the set of speech articulators and a hard vocal tract reference.

Specific example 23. The system of specific example 1, wherein the housing comprises an elastomeric surface in contact with a head surface of the user.

Specific example 24. The system of specific example 1, wherein the housing comprises a first segment opposing a second segment across the zygomatic arch.

Specific example 25. The system of specific example 10, wherein the sensor is a flexural ultrasonic transducer operating at less than 1 MHz.

Specific example 26. The system of specific example 10, wherein the model determines the linguistic unit based on a difference between time-adjacent ultrasound signals.

Specific example 27. The system of specific example 1, wherein the sensor is retained anterior to a tragus of the user.

Specific example 28. The system of specific example 1, wherein the system excludes sensors below a chin of the user.

Specific example 29. The system of specific example 1, wherein the housing further comprises a biasing mechanism that biases the anterior segment against a face of the user.

Specific example 30. The system of specific example 1, wherein the housing comprises an anterior segment an anterior segment arranged at a preauricular region of the user.

Specific example 31. The system of specific example 10, wherein the set of subvocal speech signals excludes a biosignal.

Specific example 32. The subvocal speech system of specific example 10, wherein the postauricular housing segment is arranged behind an earlobe and over a mastoid process of the user; and wherein the subvocal speech system further comprises an RF sensor arranged within the postauricular segment.

Specific example 33. The subvocal speech system of specific example 10, wherein the model infers the linguistic unit from the set of subvocal speech signals comprising ultrasound reflections and motion data.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures. However, unbroken lines in the figures should not be interpreted to indicate that the depicted elements are essential, nor to indicate that the depicted elements may not be omitted from variants of the invention.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A system comprising:
a headset comprising:
a housing arranged at an auricular region of the user;
a set of sensors arranged in the housing, targeting a measurement region of the user, wherein a set of measurements sampled by the set of sensors comprises biophysical signals from the measurement region, and
an acoustic speaker arranged in the housing and oriented toward an ear of the user; and
a model trained to determine a linguistic unit from a set of subvocal speech signals indicative of parameters of a set of speech articulators of the user, wherein the set of subvocal speech signals comprise biophysical signals sampled using the set of sensors.

2. The system of claim 1, wherein the set of sensors comprises an active sensor.

3. The system of claim 2, wherein a signal path of the active sensor traverses oral soft tissue.

4. The system of claim 2, wherein the active sensor is:
aligned with a skull gap between a zygomatic arch and a mandible of the user; and
oriented toward an oral cavity of the user.

5. The system of claim 1, further comprising a head pose sensor, wherein the model is further trained to account for head position-induced variations in the set of subvocal speech signals using measurements sampled by the head pose sensor.

6. The system of claim 5, wherein the head pose sensor comprises an inertial measurement unit.

7. The system of claim 1, wherein the set of sensors comprises an electromyography sensor.

8. The system of claim 1, wherein the set of sensors comprises a radio frequency sensor.

9. The system of claim 1, wherein the set of sensors comprises an ultrasound sensor.

10. A subvocal speech system comprising:
a set of sensors, wherein:
the set of sensors are configured to transcutaneously measure a set of subvocal speech signals associated with speech articulator motion, and
the set of sensors are arranged within a preauricular housing segment and a postauricular housing segment, wherein:
the preauricular housing segment opposes the postauricular housing segment across an ear of a user, and
the preauricular housing segment is biased against a preauricular region of the user by a biasing mechanism of the housing; and
a processor comprising a model configured to infer a linguistic unit based on the set of subvocal speech signals.

11. The subvocal speech system of claim 10, wherein the set of sensors comprises an electromyography sensor.

12. The system of claim 10, wherein set of sensors comprises a radiofrequency sensor.

13. The subvocal speech system of claim 10, wherein the set of sensors comprises an ultrasound sensor.

14. The subvocal speech system of claim 10, further comprising a front facing camera mounted to the preauricular housing segment and oriented toward an environment of the user.

15. The subvocal speech system of claim 14, wherein the processor further comprises a computer vision model configured to extract a set of user gestures based on images measured by the front facing camera.

16. The subvocal speech system of claim 10, further comprising a time of flight sensor oriented toward a cheek of the user and a mouth of the user.

17. The subvocal speech system of claim 10, further comprising a communication module configured to transmit speech, generated from the linguistic unit, to another user.

18. The subvocal speech system of claim 10, wherein:
the set of sensors further comprises a microphone; and
the processor is configured to switch between a spoken mode and a subvocal speech mode when an ambient volume measured at the microphone exceeding a predetermined threshold.

19. The subvocal speech system of claim 10, wherein the set of sensors comprises an inertial measurement unit.

20. The subvocal speech system of claim 10, wherein a first sensor in the set of sensors is oriented to target a different physiological structure of the user than a second sensor in the set of sensors.
